(19) United States
(12) Patent Application Publication
(10) Pub. No.: US 2015/0072779 A1
(43) Pub. Date: Mar. 12, 2015

(54) GAME CONTROL DEVICE, GAME CONTROL METHOD, PROGRAM, RECORDING MEDIUM, GAME SYSTEM

(71) Applicant: KONAMI DIGITAL ENTERTAINMENT CO., LTD., Minato-ku, Tokyo (JP)

(72) Inventors: Nobuya Kitamura, Setagaya-ku (JP); Hisaharu Shimose, Kawagoe-shi (JP); Hideyuki Suzuki, Funabashi-shi (JP)

(21) Appl. No.: 14/395,041

(22) PCT Filed: Apr. 4, 2013
(86) PCT No.: PCT/JP2013/060285

§ 371 Date: Oct. 16, 2014

(30) Foreign Application Priority Data
Apr. 20, 2012 (JP) 2012-096365

(51) Int. Cl. A63F 13/69

(52) U.S. Cl. CPC A63F 13/69
USPC 463/29

(57) ABSTRACT

A game control device includes an associator configured to associate a game-playing user with one or more users; an executor configured to execute a game for the game-playing user; an acquirer configured to acquire execution-related information indicating execution status in the game with regard to the one or more users, based on information of an operational input by the game-playing user; and a provider configured to provide the game-playing user with a benefit in the game, based on the execution-related information acquired by the acquirer.

### CROSS-REFERENCE TO RELATED APPLICATION

The present invention is based upon and claims the benefit of priority of the prior Japanese Patent Application No. 2012-096365, filed on Apr. 20, 2012, the entire contents of which are incorporated herein by reference.

### FIELD

The present invention relates to a technique for controlling a progress of a game for respective users.

### BACKGROUND

Recently, so-called social network games have become widespread which run on game applications created on the basis of operating environments such as application programming interfaces (API) operated on a web browser in a social networking service (SNS) provided by a particular service provider. Social network games may be defined as a type of online game played among a plurality of unspecified users who are communicating with each other. A user who has a communication terminal connectable to the Internet and with a web browser installed is able to enjoy social network games regardless of time or location.

One characteristic of the abovementioned social network game is that communication functions for socializing between users are more sophisticated than those of conventional online games. For example, in social network games, besides collaborative play with other users (friends), users exchange information through communication with friends such as greetings and contacts, and give or exchange items in the game with friends. In the digital card game (Dragon collection (registered trademark)) disclosed in a Japanese game magazine “Appli Style, Vol. 5” (published by Eastpress Co., Ltd.) p. 7-8, items are distributed to respective users based on a number of login users.

### SUMMARY OF THE INVENTION

Some conventional social network games applies a method to execute a game cooperatively among users (friends) who are associated with each other. With this method, a user obtains an item in a game at randomly-defined time while playing the game. With this method, it is configured such that if the user (game-playing user) sends the item to his or her friend(s), the user and his or her friend(s) are provided with an advantageous effect in the game. However, with this conventional method, a main purpose of playing the game for the game-playing user is to progress the game, and the item that the game-playing user can send to his or her friends is randomly obtainable during progressing the game. Thus, the user cannot realize that he or she progresses the game cooperatively with the friends. For example, the user is less likely to be motivated to progress the game primarily for the purpose of helping the friends.

The present invention has been devised in consideration of the above. An object of the present invention is to provide a game control device, a game control method, a program, a recording medium, and a game system that allow a game-playing user to realize that the game-playing user progresses a game cooperatively with the other users (friends) who are associated with the game-playing user.

A first aspect of the present invention is a game control device including:

an associator configured to associate a game-playing user with one or more users;

an executor configured to execute a game for the game-playing user;

an acquirer configured to acquire execution-related information indicating execution status in the game with regard to one or more users, based on information of an operational input by the game-playing user; and

a provider configured to provide the game-playing user with a benefit in the game, based on the execution-related information acquired by the acquirer.

In this game control device, the game may include a plurality of parts. The acquirer may acquire the execution-related information for each of the plurality of parts with regard to the one or more users, and the provider may provide the game-playing user with the benefit in the game based on the execution-related information acquired by the acquirer for each of the plurality of parts.

In this game control device, the game may include a plurality of parts. The execution-related information may be a number of parts among the plurality of parts, the number of parts depending on execution results that each satisfy a criterion, the number of parts being played by the one or more users.

In this game control device, the provider may increase the benefit as the number of parts increases.

In this game control device, the game may include a plurality of parts. The execution-related information is a total number of parts depending on execution results that each satisfy a criterion, the total number of parts being played by the one or more users.

In this game control device, the provider may increase the benefit as the total number of parts increases.

In this game control device, the execution-related information may be a parameter, the parameter being: a number of times of executing the game, a frequency of executing the game, a period of time for executing the game, or a degree of progression in the game. The acquirer may acquire parameter information for one user of the one or more users, and the one parameter information of the one user may be the greater than any parameter information of the one or more users.

In this game control device, the acquirer may acquire execution-related information with regard to the game-playing user. The provider may compare the execution-related information with regard to the game-playing user and the execution-related information with regard to the one or more users based on information of an operational input by the game-playing user, and provide the game-playing user with the benefit based on a comparison result.

In this game control device, the provider may determine the benefit in the game provided in response to the Nth operational input, based on difference between a first execution-related information acquired in response to the (N−1)th operational input and a second execution-related information acquired in response to the Nth operational input.

### BRIEF DESCRIPTION OF THE DRAWING

Referring now to the attached drawings which form a part of this disclosure:

FIG. 1 illustrates a basic configuration diagram of a game system according to an embodiment.

FIG. 2A illustrates an external appearance example of a communication terminal according to the embodiment.

FIG. 2B illustrates an external appearance example of a communication terminal according to the embodiment.

FIG. 3 is a block diagram of a configuration of a communication terminal according to the embodiment.

FIG. 4 is a block diagram of a configuration of a game server according to the embodiment.

FIG. 5 is a block diagram of a configuration of a database server according to the embodiment.

FIG. 6 illustrates an exemplary configuration of a user database that is included in the database server.

FIG. 7 illustrates an example of monster character data.

FIG. 8 illustrates a display screen of the communication terminal that displays a top page.

FIG. 9 illustrates an example of a series of web pages that are displayed on the communication terminal of a user.

FIG. 10 illustrates an example of a series of web pages that are displayed on the communication terminal of the user.

FIG. 11 illustrates an example of a series of web pages that are displayed on the communication terminal of the user.

FIG. 12 is a functional block diagram for explaining functions that play main rolls in the game control device according to the embodiment.

FIG. 13 illustrates an example of configuration of variable adjustment data indicating an increase of a variable based on notification from a friend.

FIG. 14 illustrates an example of configuration of attack power correction data indicating attack power correction factors that are applied in a battle.

FIG. 15 is a flowchart for main processing in the game server according to the embodiment.

FIG. 16 illustrates an example of configuration of playing stage data indicating data of a stage that a friend is playing when a power-up operation is performed.

FIG. 17A illustrates an example in which the functions are distributed to the communication terminal, and the game server and the database server, with regard to the game control device according to the embodiment.

FIG. 17B illustrates an example in which the functions are distributed to the communication terminal, and the game server and the database server, with regard to the game control device according to the embodiment.

### DETAILED DESCRIPTION OF THE EMBODIMENTS

The embodiment of the present embodiment will be described below.

### (1) CONFIGURATION OF GAME SYSTEM

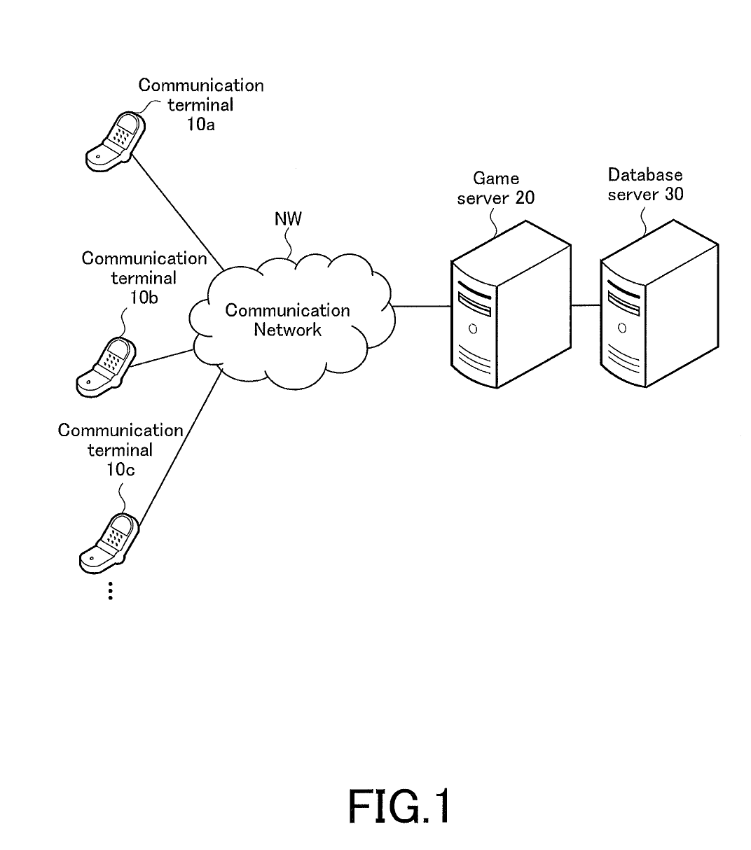

FIG. 1 illustrates an exemplary system configuration of a game system according to embodiments. As illustrated in FIG. 1, the game system includes a plurality of communication terminals 10a, 10b, 10c and etc. that are connectable to a communication network NW such as the Internet, a game server 20 that is connectable to the communication network NW, and a database server 30. Each of the communication terminals 10a, 10b, 10c and etc. is a communication terminal operated by an individual user, such as a mobile terminal, a smartphone, a personal digital assistant (PDA), a personal computer, or a television receiver including a two-way communication function (including a so-called multi-functional smart TV). It should be noted that the communication terminals 10a, 10b, 10c and etc. may be hereinafter collectively referred to as “communication terminal(s) 10.”

With this game system, the game server 20 is configured to be able to communicate with the communication terminal 10 as a client. The game server 20 provides gaming service with the communication terminal 10. The game server 20 is embedded with an application operable on a web browser as a game application in the game system. The database server 30 stores a variety of information for executing the games as described below. The database server 30 is connected to the game servers 20 by means of a wired connection for example for reading and writing the information.

The communication terminal 10 includes a web browser that is able to display a web page provided by the game server 20. A user plays a game by performing an operation on the web page displayed on the communication terminal 10.

In addition to the game server 20, an authentication server may be provided for authenticating respective users of the communication terminals 10, although not illustrated in FIG. 1. Further, if providing a plurality of the game servers 20 for receiving accesses from a large number of the communication terminals 10, a load balancer may be provided for regulating loads among the plurality of game servers 20. Furthermore, the game server 20 may be configured as a single server device or as a plurality of server devices to which functions are distributed.

### (2) COMMUNICATION TERMINAL CONFIGURATION

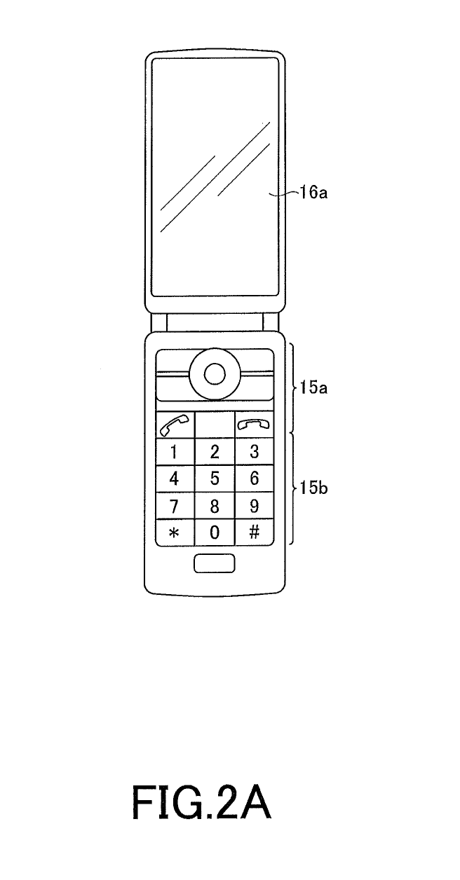

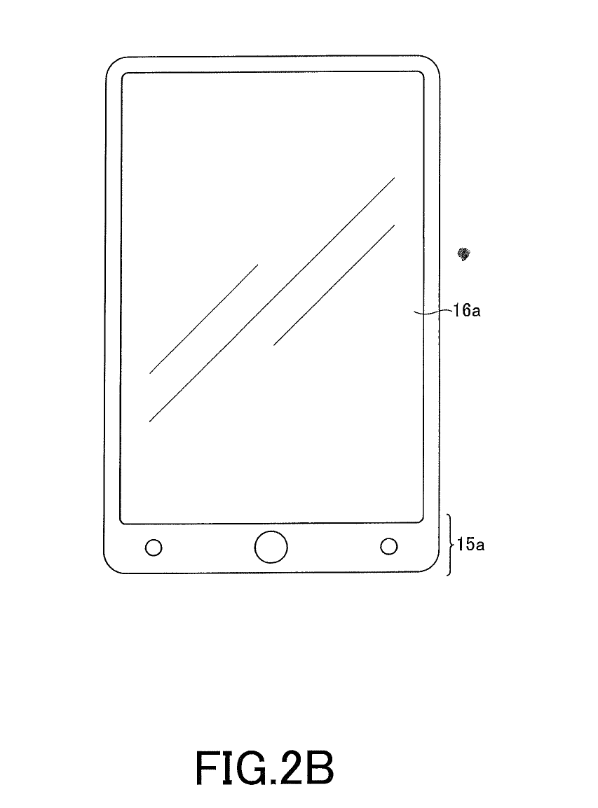

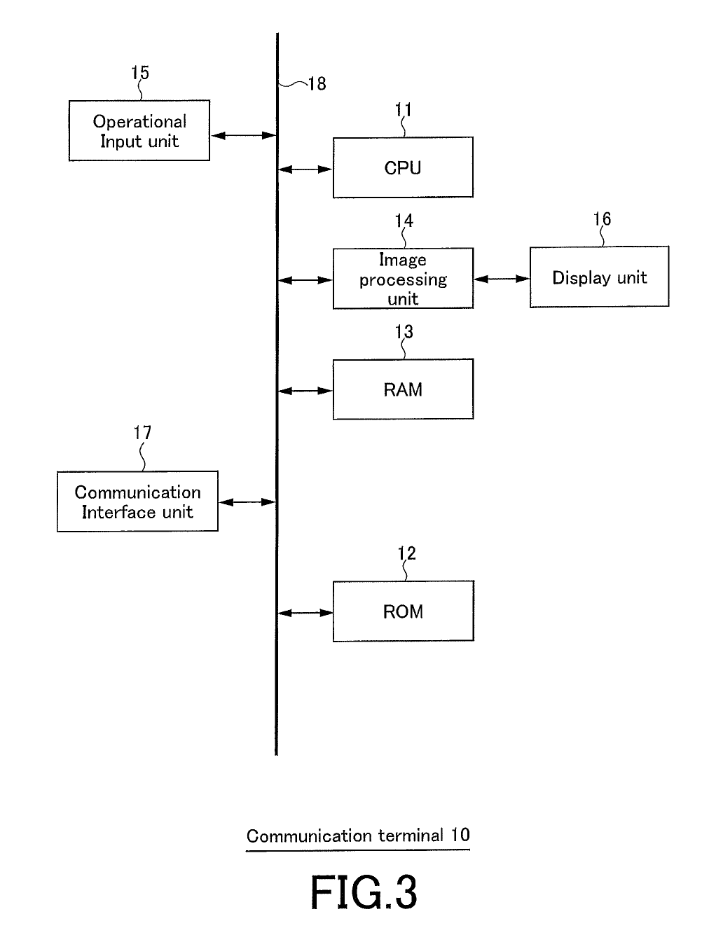

The communication terminal 10 will be hereinafter explained with reference to FIGS. 2A, 2B, and 3.

FIGS. 2A and 2B illustrate exemplary appearances of the communication terminal 10. FIG. 2A illustrates a communication terminal with a button input system such as a foldable communication terminal (mobile telephone). FIG. 2B illustrates a communication terminal with a touch panel input system such as a smartphone. FIG. 3 is a configuration block diagram of the communication terminal 10.

As represented in FIG. 3, each communication terminal 10 includes a central processing unit (CPU) 11, a read-only memory (ROM) 12, a random access memory (RAM) 13, an image processing unit 14, an operational input unit 15, a display unit 16, and a communication interface unit 17 as a signal reception unit. Further, each communication terminal 10 includes a bus 18 for transmitting control signals or data signals among the components.

The CPU 11 loads a web browser stored in the ROM 12 into the RAM 13 and runs the web browser therein. The CPU 11 acquires data for displaying a web page from the game server 20 through the communication interface unit 17 on the basis of an appropriately specified uniform resource locator (URL) that is inputted by a user using the operational input unit 15 and the like. The acquired data is data of objects such as images associated with a hypertext markup language (HTML) document and the HTML document (hereinafter collectively referred to as “HTML data” on an as-needed basis). The CPU 11 then interprets the acquired HTML data. It should be noted that each communication terminal 10 may be embedded with a variety of plug-ins for extending browsing functions of the web browser.

In acquiring the HTML data, the CPU 11 transmits an access request message to the game server 20 through the communication interface unit 17. The access request message herein includes either a preliminarily registered user ID (user identification information) or a user ID inputted through the operational input unit 15.

The web browser displays on the display unit 16 a web page provided by the game server 20 through the image processing unit 14 on the basis of the acquired HTML data. Further, when either a Hyperlink or a button on the web page is selected by a user operating the operational input unit 15, the web browser sends a request to the game server 20 (that is, a request for updating a web page; HTTP request) to transmit new HTML data for displaying the web page in accordance with the selection.

The image processing unit 14 displays a web page on the display unit 16 on the basis of image data for display to be provided from the CPU 11 as an analysis result of the HTML data. For example, the display unit 16 is a liquid crystal display (LCD) monitor including thin-film transistors arranged in a matrix manner on a pixel-by-pixel basis. The display unit 16 displays the image of the web page by driving the thin-film transistors on the basis of the image data for display on a display screen 16a.

In the case in which the mobile terminal 10 is a communication terminal to which a button input method (see FIG. 2A) applies, the operational input unit 15 is equipped with a button group 15a and a button group 15b. The button group 15a includes a plurality of operational input buttons such as a directional instruction button and a confirmation button for receiving user operational inputs. The button group 15b includes a plurality of operational input buttons such as an alphanumeric keypad and the like. The operational input unit 15 also includes an interface circuit for recognizing pressing (operating) the buttons as inputs and outputting the inputs to the CPU 11. For example, the direction instructional button is provided for instructing the CPU 11 to scroll and display a web page displayed on the display unit 16. The confirmation button is provided for instructing the CPU 11 to select one of a plurality of hyperlinks or buttons displayed on a web page. The selected hyperlink or button may be activated (e.g., highlighted). When the communication terminal 10 is a small portable terminal, the aforementioned buttons are preferably disposed on the front face of the communication terminal 10 to allow a user to easily operate (click) the buttons with the thumb of the hand holding the communication terminal 10. In the example illustrated in FIG. 2A, the button group 15b is arranged below the button group 15a and includes a plurality of operational input buttons depicted as “0” to “9”, “*”, “#” (an alphanumeric keypad).

In the case in which the mobile terminal 10 is a communication terminal to which a touch panel input method (see FIG. 2B) applies, the operational input unit 15 receives touch panel method inputs inputted by mainly touching the display screen 16a with a finger or a pen. The touch panel input method may be a known method such as a capacitance method. As illustrated in FIG. 2B, the communication terminal 10 may be provided with a button group 15a despite having the touch panel input method.

In the case in which a button input method applies to the mobile terminal 10 for example, a selection operation of a button on a web page displayed on the communication terminal 10 is performed by the following steps: selecting a button on the web page with a pressing operation of the direction instructional button and subsequently confirming the selected button with a pressing operation of the confirmation button. In the case in which a touch panel input method applies to the mobile terminal 10 for example, the selection operation is conducted by indicating (touch operation) with a finger or pen a position of a button on the display screen 16a on which the web page is displayed.

### (3) GAME SERVER CONFIGURATION

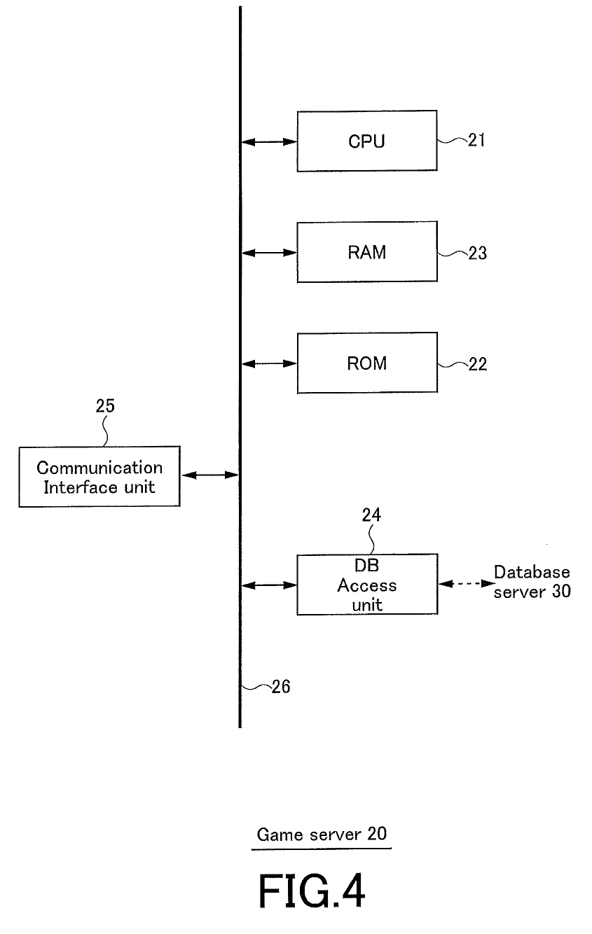

The configuration of the game server 20 will be explained with reference to FIG. 4

For example, the game server 20 manages a website of a game including a plurality of hierarchically structured web pages. The game server 20 provides a web service of the game to the communication terminals 10. As illustrated in FIG. 4, the game server 20 includes a CPU 21, a ROM 22, a RAM 23, a database (DB) access unit 24, and a communication interface unit 25. Further, the game server 20 includes a bus 26 for transmitting control signals or data signals among the components. It should be noted that the game server 20 may have the same hardware structure as general-purpose web servers.

The ROM 22 stores an application program that provides the service of displaying a HTML document and objects such as images (i.e., displaying a web page) to the web browser of the communication terminal 10 as a client. A variety of data referenceable by the CPU 21 is stored in the ROM 22 in addition to the application program.

The CPU 21 loads a game program stored in the ROM 22 into the RAM 23 and runs the loaded game program. The CPU 21 also performs a variety of processing through the communication interface unit 25.

For example, the CPU 21 transmits HTML data to the communication terminal 10 through the communication interface unit 25. Moreover, the CPU 21 performs authentication processing when the game server 20 performs authentication processing of the user of the communication terminal 10.

The CPU 21 performs processing in accordance with the hyperlink or button selected by the user on the web page displayed on the communication terminal 10 through the communication interface unit 25. The processing includes, for example, transmitting new HTML data, calculating or data processing in the game server 20.

The database access unit 24 is an interface used when the CPU 21 performs data reading and data writing with respect to the database server 30.

### (4) DATABASE SERVER CONFIGURATION

The database server 30 as a memory device can be realized by a general-purpose storage such as a high-capacity hard disk drive, a redundant array of inexpensive disks (RAID) or other form of device. Databases inside the database server 30 are configured to allow reading and writing of data by the CPU 21 through the database access unit 24 of the game server 20.

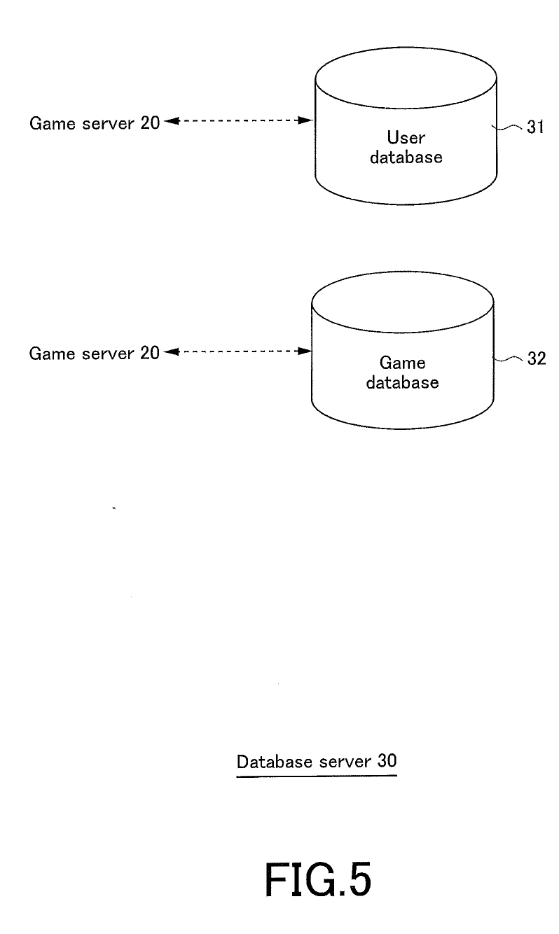

FIG. 5 illustrates an example of a database server 30 configuration. As illustrated in FIG. 5, the database server 30 includes a user database 31 and a game database 32.

The game executed by the game server 20 of the present embodiment is not limited to a game of a specific type. For convenience sake of the following explanation, a battle-type digital card game will be considered as an exemplary game. The battle-type digital card game may be referred to as “the game of the present embodiment” hereinafter. The battle-type digital card is configured such that a user plays a battle against monster characters by use of warrior card(s) that the user virtually owns in the game. The monster characters are monsters in the game.

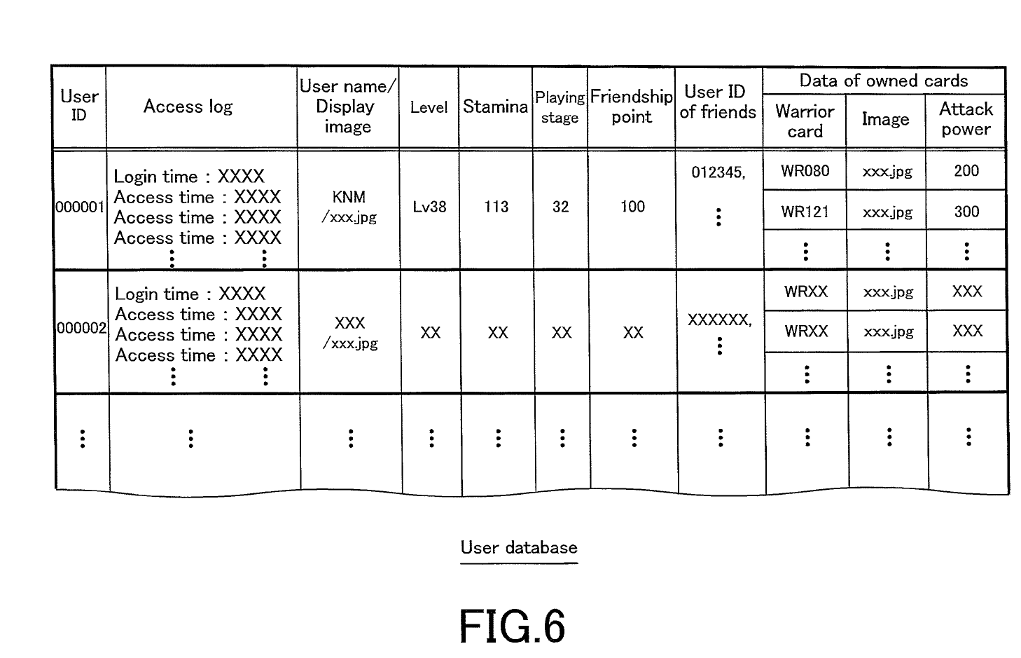

FIG. 6 illustrates an exemplary configuration of a user database 31 that is applied to the game of the present embodiment. In this example, the user database 31 includes for each user ID (user identification information): Access log, User Name/Display Image, Skill level, Stamina, Playing stage, Friendship points, User ID of friends, and Data of owned cards. Information included in the user database 31 may be updated by the game server 20.

In the following explanation, data for each user ID or for each user name (which is explained below) that identifies a user included in the user database 31 is referred to collectively as “user data.” The data of the fields that configure the user data are described below.

Access Log

“Access log” includes a login time that is a time when a user logins based on a user ID, or an access time that is a time when a user accesses based on a user ID.

User Name/Display Image

“User Name/Display Image” represents a user name and a display image displayed for identifying a user of the communication terminal 10 while executing the game. The user name is a text of a certain length or less specified in advance by the user. The display image is, for example, an avatar image selected in advance by the user. The user name is a name to identify a user in a network environment (or a game community) provided by the game server 20.

Skill Level

“Skill level” indicates a skill level of a user in the game. The skill level is a value that ranges from level 1 (Lv1) to level 100 (Lv100) for example.

Stamina

“Stamina” is points that are required when a user plays a battle between warrior card(s) and a monster character. The stamina is a value that decreases by performing one time attack against the monster character and recovers (increases) each time a certain period of time elapses.

Playing Stage

“Playing stage” is a value indicating a stage at which a user to be processed is playing a battle against a monster character in the game of the present embodiment. A value indicating a stage increases by one (namely, stage 1, stage 2, . . . ). An example of FIG. 6 indicates that a stage at which a user is playing is stage 32.

Friendship Points

“Friendship points” is points that a user obtains by sending a cheering message to his or her friend.

User ID of Friends

“User ID of friends” indicates user ID(s) of friends of a user (that is, user ID(s) of the other users who are associated with the user).

Data of Owned Cards

“Data of owned cards” is data of warrior card(s) that a user owns. As illustrated in FIG. 6, “data of owned cards” includes image and parameters such as attack power for respective warrior card(s). In a battle between the warrior card(s) and the monster character, the warrior card(s) cause damage to the monster character in accordance with respective values of the attack power.

Referring now back to FIG. 5, the game database 32 stores and updates information with regard to progression of the game executed by the game server 20 and monster character data. The information with regard to progression of the game may include various types of information according to nature of the game. In the game of the present embodiment, that information may include detailed results for battles against monster characters in each stage for respective users.

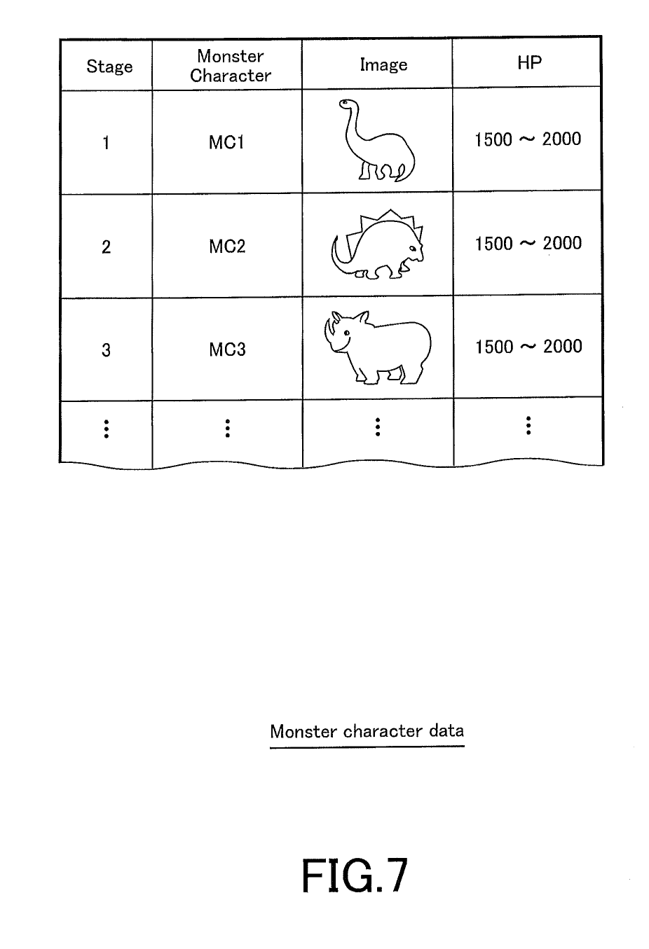

FIG. 7 illustrates an example of the monster character data. The monster character data includes data of monster characters each set for different stages. The monster character data is loaded from the game database 32 to the RAM 23 for example when battle processing is initiated. In FIG. 7, an image and a value of HP (Hit Point) correspond to respective monster characters MC1, MC2, MC3, . . . that each appear in different stages. HP of each monster character is in a range of 1,500 to 2,000 in FIG. 7 for example, while a default value of HP for a battle may be randomly set within the range.

### (5) GAME ACCORDING THE PRESENT EMBODIMENT

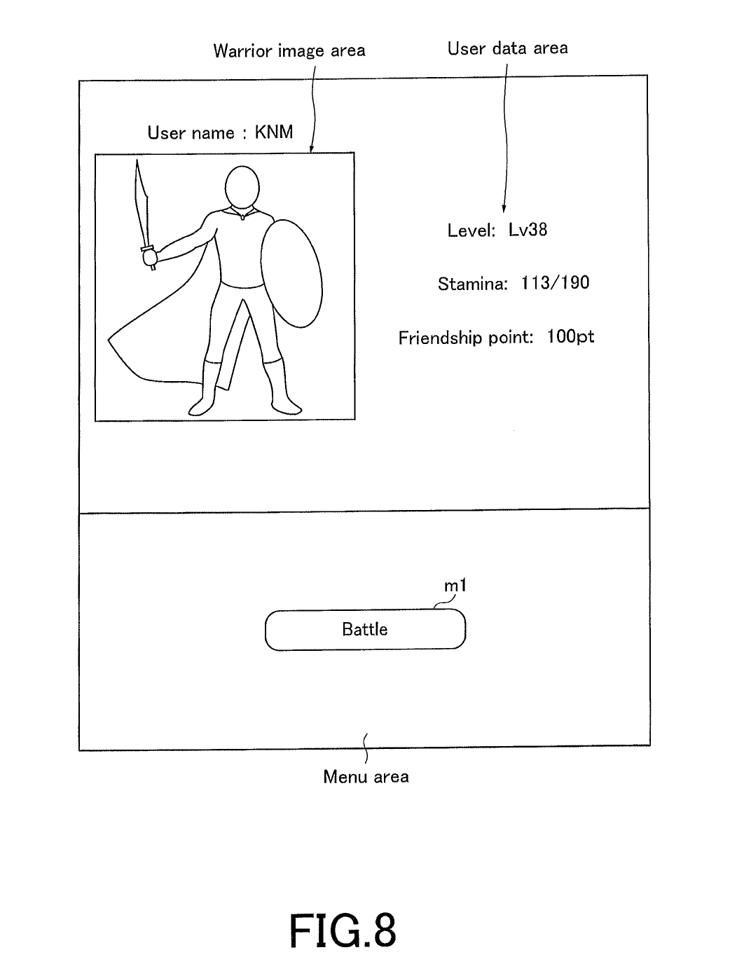

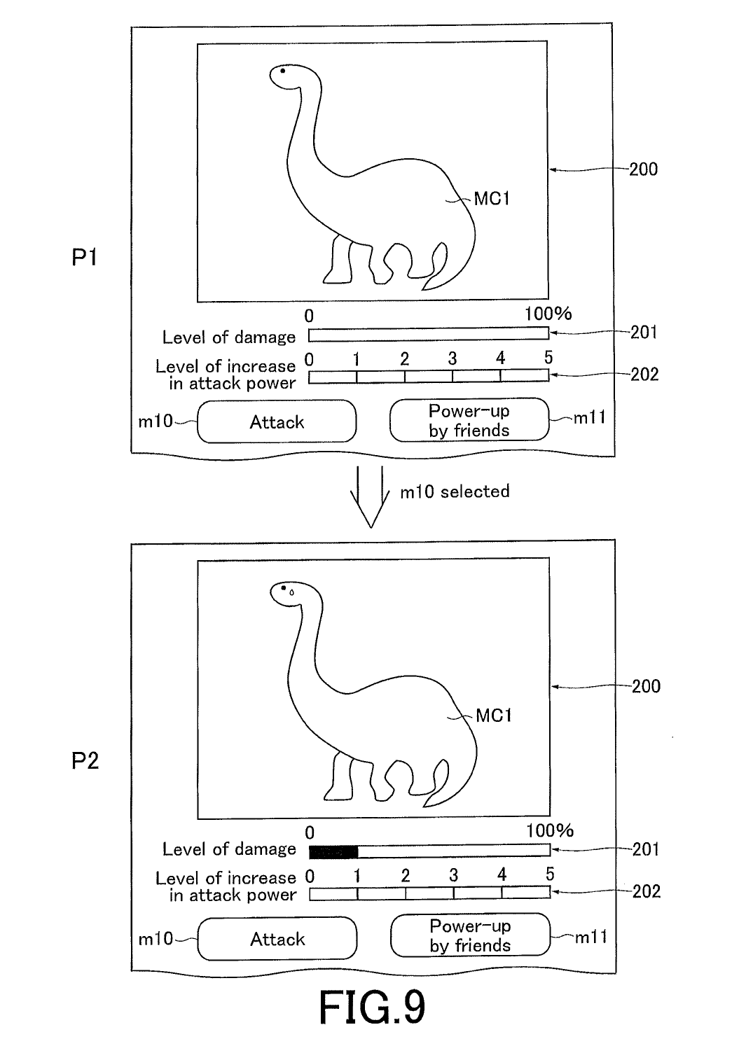

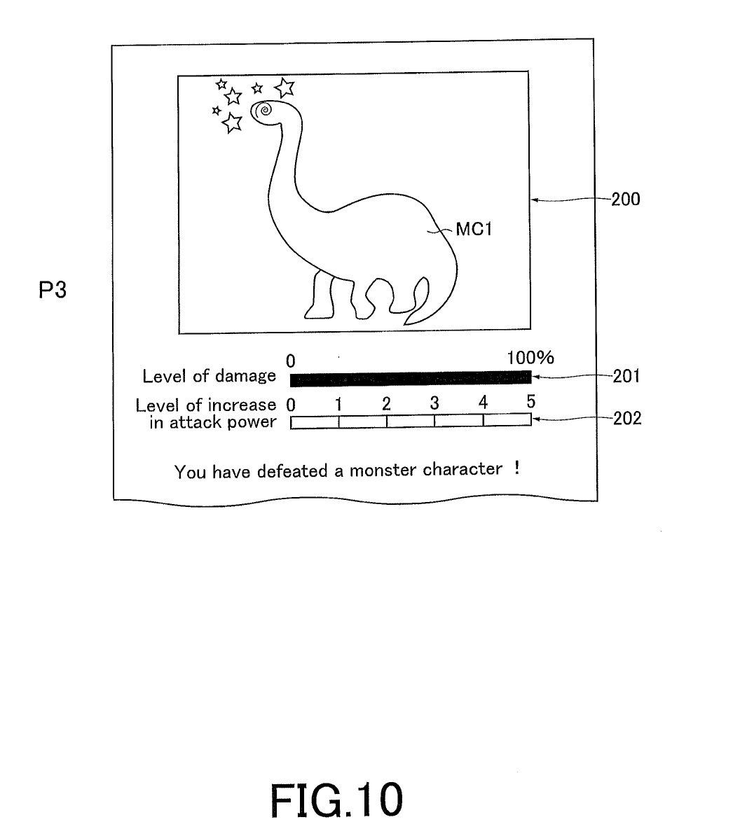

Specifically, battle processing in the game of the present embodiment will be described hereinafter with reference to FIGS. 8 to 12. FIG. 8 illustrates an example of a top page that is displayed on a communication terminal 10 in the game of the present embodiment. FIGS. 9 to 12 illustrate an example of web pages that are displayed on a communication terminal 10 in the battle processing.

Note that the battle processing is an example of a game element in a plurality of game elements that may be provided in the game of the present embodiment.

The top page illustrated in FIG. 8 is a web page for respective user IDs. The top page illustrated in FIG. 8 includes a user data area, a warrior image area, and a menu area.

The user data area is an area in which respective fields of user data for a user ID to be processed is displayed (see FIG. 6). The displayed fields are: Level, Stamina, and Friendship points. Display of “113/190” in the field of stamina indicates that the present stamina of the user is “113” and the maximum value of the stamina is “190.”

The warrior image area is an area in which image of a warrior card is displayed. A warrior card to be displayed is specified by a user among a plurality of warrior cards that are included in the user data for the user ID to be processed.

The menu area is an area for displaying a plurality of buttons that includes a button ml for initiating the battle processing in the game of the embodiment. Buttons other than the button ml are not shown in FIG. 8.

The updated web page P1 is displayed in response to a selection operation to the button ml on the top page of FIG. 8. The web page P1 is configured such that a user plays a battle to defeat a monster character by use of warrior card(s) of the user while consuming the stamina. The web page P1 is initially displayed when the battle processing for a stage 1 is performed. The web page P1 includes: an area 200 for displaying a monster character that is an opponent in the battle (a monster character MC1 in the stage 1); a gauge 201 for displaying a level of damage in percent; a gauge 202 indicating a level of increase in attack power of the warrior card(s) on steps of one to five; a button m10 of “Attack”; and a button m11 of “Power-up by friends.” The gauge 201 indicates 0% when HP of the monster character (the opponent in the battle) is maximum, while the gauge 201 indicates 100% when the HP is zero. Indication of 0% in the gauge 201 means that the monster character (the opponent in the battle) has been defeated. “Level of increase in attack power” is a value indicating a degree of increase in the attack power of the warrior card(s) that the user uses in the battle. As the level of increase is greater, the attack power becomes greater than a default value.

The updated web page P2 is displayed in response to a selection operation to the button m10 on the web page P1. Compared to the web page P1, the HP of the monster character has decreased and the level of damage has increased in the web page P2 due to the attack power of the warrior card(s) used in the battle and the level of increase in the attack power. Every time the button m10 is selected, the level of damage of the monster character (the opponent in the battle) increases while stamina of the user decreases. As shown in the web page P3, reaching 100% in the level of damage indicates that the monster character has been defeated and the stage 1 has been cleared.

The game is configured such that a game-playing user can increase attack power against a monster character as an opponent at a desired time, in accordance with a degree of progression for friend(s) of the game-playing user in stages (namely, a degree of progression in the game). The button m11 in the web page P1 is a button that is provided to obtain an effect of increase in the attack power in accordance with the degree of progression for friend(s) of the game-playing user in stages.

The web page P4 is an example of a web page displayed for a game-playing user. When the button m11 (“Power-up by friends”) is selected, the updated web page P5 is displayed for example. The web page P5 includes a text area 203 for displaying a text that reports a number of monster characters that a friend of the game-playing user has defeated (that is, a number of the stages that the friend of the game-playing user has cleared). Further, in the web page P5, an example is shown in which the gauge 202 indicates that the level of increase in attack power has increased by two steps (that is, the level of increase in attack power: 0→2). This allows the user to give more damage to the monster character when selecting the button m10 (“Attack”) thereafter than before selecting the button m10.

That is, the game of the present embodiment is configured such that a game-playing user can increase attack power of a warrior card that the game-playing user uses, as a benefit in the game, in accordance with the number of the stages that the friend of the game-playing user has cleared.

### (6) OVERVIEW OF FUNCTIONS OF GAME CONTROL DEVICE

Next, respective processing in the game control device to realize the game of the present embodiment will be described.

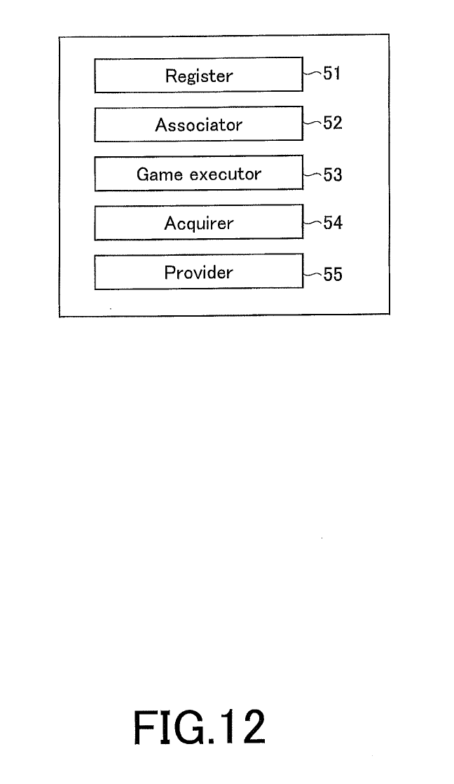

In the present embodiment, the game control device is configured, for example, by the game server 20 and the database server 30. Hereinafter, functions performed by the game control device of the present embodiment will be described with reference to FIG. 12 in the case in which the above-described battle-type digital card game is applied. FIG. 12 is a functional block diagram for explaining functions playing main rolls in the game control device according to the present embodiment.

In the following explanation, marks and buttons and the like displayed on the web pages displayed on the communication terminal 10 are arranged in preferable positions on the web pages. The positions on the display screen of the buttons and marks and the like made visible by the communication terminal 10 may be changed with a scrolling operation of the web page by the user using a direction instructional button or touch panel operation.

The register 51 includes a function for recognizing a user request and performing registration processing in response to an operational input to the communication terminal 10 on a web page for example that is provided to the communication terminal 10. The registration processing is performed when a user is registered in the game (that is, user registration).

The function of the register 51 may be realized, for example, as described below. The CPU 21 of the game server 20 receives a registration request message from the communication terminal 10 through the communication interface unit 25. The web page provided by the game server 20 may be configured so that a registration request message is automatically generated by a certain operation (e.g., a selection of a certain button, or input of text of user ID and password, etc.) to the communication terminal 10 on the web page. Information (e.g., an IP address or an email address and the like) for identifying the communication terminal 10 that is the transmission source may be included in the registration request message. Alternatively, in the case in which the user plays the other game(s) from the same service provider, the registration request message may include the user ID of that user.

If the CPU 21 receives the registration request message in which a user ID is not included, the CPU 21 issues a new user ID and processes the new user ID, and then transmits a message to the communication terminal 10 indicating the fact that the registration processing has been completed. If the CPU 21 receives the registration request message in which a user ID is included in the registration request message, the CPU 21 processes that user ID, and then transmits a registration completion message to the communication terminal 10.

When the registration is completed, the CPU 21 prepares user data corresponding to the user ID and stores the user data in the user database 31. Once the registration is completed, the user corresponding to the user ID can start playing the game of the present embodiment.

The associator 52 includes a function for associating a user with one or more users. For example, when receiving an application based on a user ID, the associator 52 associates the user ID with the other user ID as friends.

The function of the associator 52 will be realized for example as described below. The CPU 21 of the game server 20 receives an application message (application) that specifies a user ID (or the corresponding user name) to desirably be friends with, from the communication terminal 10 of the user corresponding to a certain user ID through the communication interface unit 25. The transmission of the application message may be preset as a function of the web page provided to the communication terminal 10 of the user. Upon receiving the application message, the CPU 21 transmits HTML data to the communication terminal 10 corresponding to the user ID, when access occurs based on the user ID included in the application message. The transmitted HTML data is for displaying a web page to request for replying whether or not the application on the basis of the other user ID is approved. The CPU 21 registers both users as friends if a message of approval of the application is returned. Specifically, the CPU 21 writes the data in the “friend” field (see FIG. 6) of the user data of the two corresponding user IDs in the user database 31.

A condition under which users are associated with each other is not limited to one that requires application and approval, which is described above. Whether the condition is satisfied may be automatically judged based on a criterion irrespective of a user's operation. For example, users may be automatically registered as friends (that is, users who are associated with each other in the game) when they play an identical stage of an identical game or when they play a battle together. Alternatively, users who transmits greeting messages to each other at predetermined times may be automatically registered as friends. If a battle play is embedded in a game, users who play battles together at predetermined times may be automatically registered as friends.

In the case in which a group (guild, etc.) of users is set in a game, after participation of a user (referred to as “User_A”) in a group is approved, other user(s) in the group may be registered as friend(s) of User_A.

In the present embodiment, an example is disclosed in which registration of users as friends is realized by writing data into the user database 31; however, registration of users as friends is not limited to such example. Data with regard to friends may be written to an external memory device in the network accessible from the game server 20.

The game executor 53 includes a function for performing login authentication for respective users and managing access time (that is, time of access for performing battle processing in the game or performing battle processing of a specific stage in the game). The function of the game executor 53 will be realized as described below. When receiving a HTTP request from the communication terminal 10 of the respective users, the CPU 21 of the game server 20 performs authentication processing and updates information with regard to login status. In the authentication processing, the CPU 21 collates identification information, or a user ID and a password included in the HTTP request, with identification information, or a user ID and a password recorded in the user data of the user database 31. Further, the CPU 21 accesses to the user data to update information with regard to login status.

The game executor 53 includes a function for executing the game by updating a web page that is displayed on the communication terminal 10 in response to a request from the communication terminal 10. More specifically, according to the game executor 53, the CPU 21 of the game server 20 receives a HTTP request from the communication terminal 10, and performs processing in the game (such as battle processing) in response to the HTTP request. Then, CPU 21 transmits to the communication terminal 10 a HTTP response that includes HTML data as a game execution result.

The function of the game executor 53 will be realized as described below in the case in which the top page of FIG. 8 is displayed on the communication terminal 10 of the user. When receiving a HTTP request that requests data for the top page, the CPU 21 of the game server 20 accesses to the user database 31 through the database access unit 24, and reads out data of respective fields included in the user data area and image data of a warrior card to be displayed in the warrior image area. Then, the CPU 21 generates HTML data such that the top page of FIG. 8 is displayed, and transmits a HTTP response including the HTML data to the communication terminal 10. The generated HTML data differs for respective users (that is, respective user IDs). The communication terminal 10 interprets the HTML that it receives, and displays the image of the top page on the display unit 16 (display screen 16a).

The CPU 21 performs battle processing in response to a selection operation of the user to the button ml on the top page. The battle processing with regard to a battle against a monster character will be described hereinafter.

[Battle Processing with Regard to a Battle Against a Monster Character]

In the battle processing with regard to the battle against the monster character, the CPU 21 of the game server 20 acquires a selection result of a predetermined number of warrior cards that participate in the battle in response to an appropriate operation. The predetermined number of the warrior cards is selected among warrior cards that a user owns. In the following explanation, it is assumed for the sake of easiness in understanding that one warrior card participates in the battle. The CPU 21 reads out data of a monster character that corresponds to a stage to be played by the user, among data of monster characters that are recorded in the game database 32. The CPU 21 then writes the data of the monster character in the RAM 23. Here, a default value of HP of the monster character is randomly determined for the battle. For example, the HP of the monster character MC1 is set in a range of 1,500 to 2,000 in the stage 1 in accordance with the monster character data, while a default value of the HP for the battle is randomly determined from the range of 1,500 to 2,000. Data of the warrior card is read out from the user data and written into the RAM 23.

When the user attacks the monster character using a warrior card (that is, when the button m10 on the web page P1 of FIG. 9 is selected for example), the CPU 21 decreases the HP of the monster character in accordance with a value of attack power of the warrior card. Here, the value of the attack power of the warrior card is basically fixed as illustrated in FIG. 6. Nevertheless, the attack power is increased in response to a selection operation to the button m11 (“Power-up by friends”). In the following explanation, a selection operation to the button m10 (“Attack”) is referred to as “attack operation”, while a selection operation to the button m11 (“Power-up by friends”) is referred to as “power-up operation.”

Let Pa stand for the attack power of the warrior card. Further, let K stand for an attack power correction factor that may vary in response to the power-up operation. The attack power correction factor K indicates a degree of increase in attack power. Calculation with regard to the HP of the monster character will be performed with a single attack operation in accordance with an equation (1), which is described below. Note that a default value of K is “1.” The updated value of the HP is sequentially overwritten into the RAM 23 while performing the battle processing.

HP=HP−Pa*K (1)

It is appreciated from the equation (1) that, if the attack power correction factor K is greater than one, the HP decreases largely and the monster character is defeated faster compared to the case of K=1.

The CPU 21 calculates a level of damage of the monster character based on the value of the HP that is sequentially updated with attack operations. Let DL (%) stand for a value of the level of damage in percent. DL is calculated in accordance with an equation (2), which is described below. In the equation (2), HP0 indicates a default value of HP of a monster character. The updated DL is sequentially overwritten into the RAM 23 while performing the battle. A position of the gauge 201 is determined based on the updated DL.

DL=(HP0−HP)/HP0*100 (2)

The CPU 21 decreases stamina of the user by a predetermined value for example in response to an attack operation. That is, when recognizing the attack operation, the CPU 21 accesses to the user data to update (decrease) the stamina.

In the present example, the battle processing with regard to the battle against the monster character is performed based on the attack power of the warrior card that the user owns; however, a method of the battle processing is not limited to one described above. For example, a value that is randomly determined within a prescribed range in response to the attack operation may be applied as Pa in the equation (1) instead of the attack power of the warrior card.

If the updated HP of the monster character becomes zero, the CPU 21 proceeds to perform battle processing of the next stage for a game-playing user. That is, the CPU 21 reads out data of a monster character that corresponds to the next stage from the monster character data that is recorded in the game database 32, and loads the data of the monster character to the RAM 23.

The acquirer 54 includes a function for acquiring a number of the stages that a friend of a game-playing user has cleared, based on information of an operational input.

In the present embodiment, execution-related information in the game is, but not limited to as described later, a degree of progression in the game for example. Note that the number of the stages that has been cleared is an example of the degree of progression in the game.

In the present embodiment, “information of an operational input” is information with regard to a request for updating a web page (namely, a HTTP request) in response to a power-up operation (that is, a selection operation to the button m11).

The function of the acquirer 54 will be realized as described below. The CPU 21 of the game server 20 receives a HTTP request from the communication terminal 10 and recognizes that a power-up operation is performed. The CPU 21 then accesses to user data of the game-playing user and reads user ID(s) of the friend(s) of the game-playing user. Based on user data corresponding to the user ID(s) that has been read, the CPU 21 then reads a value of a playing stage for respective friend(s). The game of the present embodiment is configured to progress from the stage 1 in order, and accordingly a playing stage in user data (that is, a number of stages that have been cleared) is considered as information with regard to the degree of progression in the game.

The acquirer 54 may further include a function for notifying the game-playing user of execution-related information indicating game execution status with regard to a friend of the game-playing user. In the present embodiment, a number of stages that have been cleared is an example of the execution-related information. With this function, the game-playing user can recognize visually or auditorily that he or she obtains a benefit as a result of an accomplishment by the friend in the game. Thus, the game-playing user can realize that he or she is progressing the game in cooperation with the friend in the game. In the present embodiment, the benefit is that the game-playing user can progress the game advantageously by increasing attack power of a warrior card that the game-playing user uses, which will be described later.

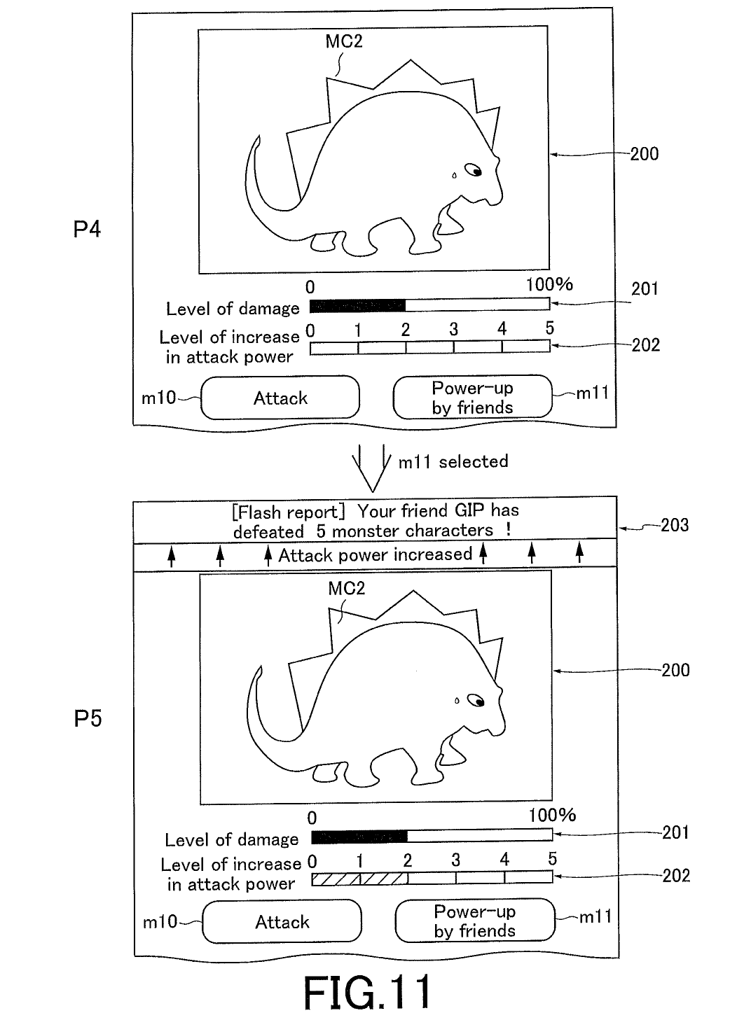

The function of notification according to the acquirer 54 will be realized as described below. When acquiring information with regard to a number of stages that the friend of the game-playing user has cleared, in response to the power-up operation, the CPU 21 of the game server 20 transmits text data to the communication terminal 10 of the game-playing user. The text data includes a name of the friend and the number of the stages that the friend has cleared. An example of a content of the text data is shown in the text area 203 in the web page P5 of FIG. 11. Alternatively, the CPU 21 generates HTML data including the text data in response to a request for updating a web page for the game-playing user. In the example of the web page P5 of FIG. 11, the game-playing user is notified through text data; however, the game-playing user is not only notified through visualized information. The game-playing user may be notified through voice information.

In the following explanation, as indicated in the text area 203 of the web page P5 of FIG. 11, notification in text data that is displayed in the text area 203 in response to the power-up operation is referred to as “flash report.”

The provider 55 includes a function for providing the game-playing user with a benefit in the game based on the execution-related information, which is acquired by the acquirer 54, with regard to the friend(s) of the game-playing user. In the present embodiment, a degree of progression in the game (that is, a number of stages that have been cleared) is an example of the execution-related information. In the present embodiment, the benefit is that the game-playing user can progress the game advantageously by increasing attack power of a warrior card that the game-playing user uses.

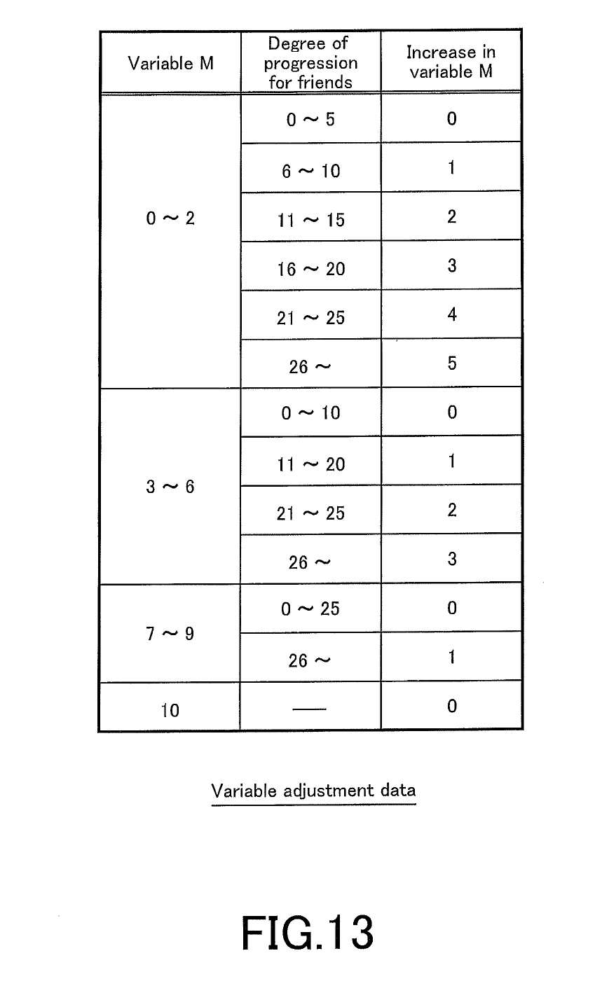

The function of the provider 55 will be realized as described below. The CPU 21 of the game server 20 manages a variable M (M: Integer equal to or greater than zero) that specifies an attack power correction factor K for increasing attack power of a warrior card in a battle against a monster character. The variable M is associated with a game-playing user. The default value of the variable M is zero, while the maximum value of the variable M is ten for example. The variable M increases at a desired time by the game-playing user (namely, a time when the power-up operation is performed), in accordance with a number of stages that the friend of the game-playing user has cleared. Increase in the variable M is exemplified in FIG. 13, though the increase may be arbitrarily set. FIG. 13 illustrates relation of: a variable M for the game-playing user, a degree of progression in the game for the friend of the game-playing user (the number of the stages that the friend has cleared, for example), and an increase in the variable M.

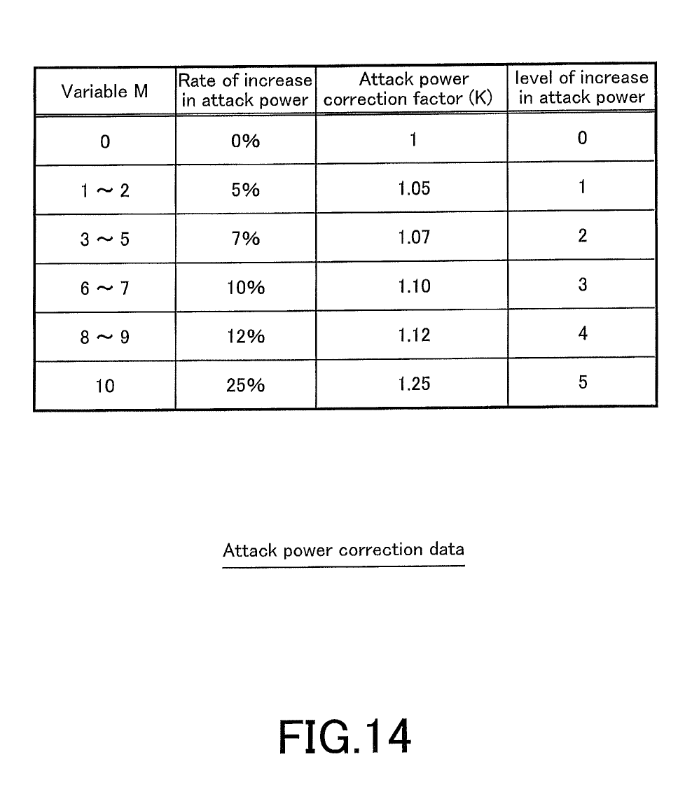

According to this example of the increase in the variable M shown in FIG. 13, the maximum value of the increase in the variable M is large as the variable M for the game-playing user is small, while the maximum value of the increase in the variable M is small as the variable M for the game-playing user is large. The variable M is decremented by one every time an attack operation is performed by the user. The example of FIG. 14 is configured such that a status in which a large value of the variable M does not last long in consideration of fairness in the game.

The example of the increase in the variable M shown in FIG. 13 is preferable in that the increase in the variable M becomes large as the number of the stages that the friend of the game-playing user has cleared increases. That is, the more stages the friend of the game-playing user has cleared, the larger the increase in the variable M for the game-playing user is. This allows attack power to increase while the game-playing user is playing the battle against a monster character. Thus, the more stages the friend of the game-playing user has cleared, the more easily the game-playing user can clear his or her playing stage. Thereby, synergy effect occurs while the game-playing user and the friend are progressing the game, and accordingly the game-playing user can realize that he or she is playing battles in cooperation with the friend.

Note that the variable adjustment data illustrated in FIG. 14 is recorded in the ROM 22 for example.

The CPU 21 determines the attack power correction factor K of the warrior card that the user uses and a level of increase in the attack power that is indicated by the gauge 202 on a web page based on the variable M for the user. For the determination, the CPU 21 refers to the attack power correction data that is exemplified in FIG. 14. As illustrated in FIG. 14, in the attack power correction data, a variable M, a rate of increase in attack power, an attack power correction factor K, and a level of increase in attack power are corresponded to each other. The attack power correction data is recorded in the ROM 22 for example. In FIG. 14, the rate of increase in attack power is a value in percent that corresponds to the attack power correction factor K. As illustrated in FIG. 14, as the variable M increases, both the attack power correction factor K and the level of increase in attack power increase together.

The attack power correction factor K based on the attack operation, which is determined in accordance with the variable M, is used in processing to update the HP of the monster character (see the equation (1)). When the power-up operation is performed, the variable M increases in accordance with the number of the stages that the friend of the game-playing user has cleared; accordingly the attack power of a warrior card that the game-playing user uses increases. Therefore, the game-playing user is provided with a benefit in the game that the HP of the monster character is zeroed and accordingly the game is progressed faster. Note that five levels 1 to 5 of increase in attack power are prepared in accordance with the variable M, that is, in accordance with the attack power correction factor K. This is because it makes the user easier to visually recognize a degree of increase in the attack power of the warrior card of the user.

### (7) MAIN PROCESSING FLOW OF THE GAME CONTROL DEVICE OF THE PRESENT EMBODIMENT

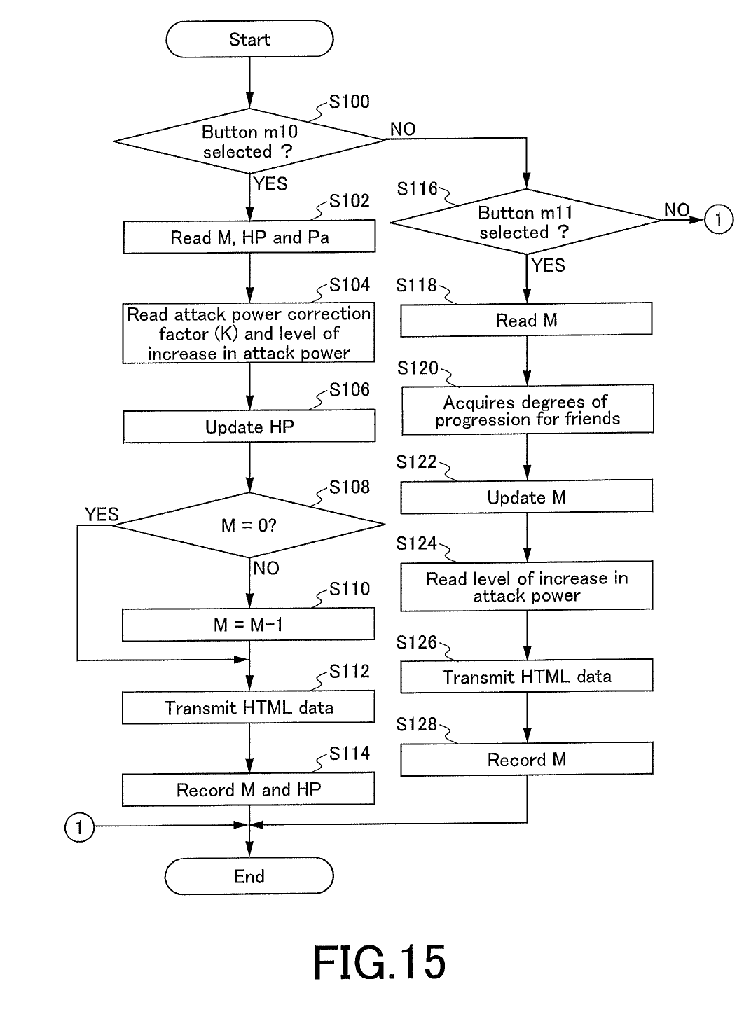

The following is an explanation about an example of a main processing flow performed by the game control device according to the present embodiment with reference to the flowchart of FIG. 15. The flowchart of FIG. 15, which is performed by the game control device according to the present embodiment, indicates battle processing in the game according to the present embodiment.

After recognizing that the button m10 has been selected in the web page of battle processing (that is, after recognizing an attack operation) (Step S100: YES), the CPU 21 of the game server 20 performs a series of processing since Step S102. If a selection operation to the button m10 has not been recognized (Step S100: NO), the CPU 21 proceeds to Step S116. If the Step S100 is judged to be YES, the CPU 21 first reads from the RAM 23: a variable M for a game-playing user, a HP of a monster character (an opponent in the battle) in accordance with a stage to be processed, and attack power Pa of a warrior card that the game-playing user uses in the battle (Step S102).

After the variable M is read, the CPU 21 refers to the attack power correction data exemplified in FIG. 14 and reads an attack power correction factor K and a level of increase in attack power (Step S104). Based on the attack power correction factor K that has been read, the CPU 21 updates the HP of the monster character according to the equation (1) (Step S106). If the variable M is not zero (Step S108: NO), the CPU 21 decrements the variable M (Step S110). That is, the variable M is decremented by one for each attack operation. If the variable M is zero (Step S108: YES), the CPU 21 skips the Step S110 to proceed to Step S112. The CPU 21 generates HTML data in response to the attack operation in the Step S100 and transmits the HTML data to the communication terminal 10 of the game-playing user (Step S112). A web page that is displayed based on the HTML data includes the gauge 202 and the gauge 201. The level of increase in the attack power that has been read in the Step S104 is reflected in the gauge 202, while the HP that has been updated in the Step S106 is reflected in the gauge 201. Finally, the CPU 21 records the updated variable M and the updated HP of the monster character into the RAM 23 (Step S114), and terminates the battle processing.

Although not illustrated in FIG. 15, if the HP of the monster character becomes zero, the CPU 21 terminates the stage to be processed (that is, judges that the stage has been cleared) and proceeds to the next stage.

On the other hand, if the selection of the button m10 has not been recognized (Step S100: NO), the CPU 21 proceeds to Step 116 to judge whether the button m11 has been selected. Here, if selection of the button m11 (namely, the power-up operation) has been recognized (Step S116: YES), the CPU 21 first reads a variable M of the game-playing user form the RAM 23 (Step S118). Then, the CPU acquires, from user data for respective friends of the game-playing user, a degree of progression in the game for the respective friends of the game-playing user, that is, a number of stages that the respective friends have cleared (Step S120). Based on the variable M that has been read in Step S118 and the number of the stages that the respective friends of the game-playing user, the CPU 21 refers to the variable adjustment data (see FIG. 13) and determine increase of the variable M to update the variable M (Step S122). Then, the CPU 21 refers to the attack power correction data exemplified in FIG. 14 to read a level of increase in the attack power (Step S124). The CPU 21 generates HTML data in response to the power-up operation in Step S116 and transmits the HTML data to the communication terminal 10 of the game-playing user (Step S126). A web page that is displayed based on the HTML data includes the gauge 202 that indicates the level of increase in the attack power that has been read in Step S124. Finally, the CPU 21 records the updated variable M in the RAM 23 (Step S128) and terminates the battle processing. If the selection of the button m11 has not been recognized in Step S116, the CPU 21 also terminates the battle processing.

The variable M increases by performing Steps S118 to S128. When the button m10 is selected thereafter, reading data in Step S104 is performed based on the increased variable M. Due to the increase in variable M, the attack power of the warrior card that the game-playing user uses increases. Thus, the game-playing user can progress the battle advantageously. That is, the HP of the monster character is reduced more largely, compared to a case in which the variable M does not increase.

In order to cause a flash report to be displayed, the CPU 21 generates the HTML data in Step S126 so as to include information with regard to a friend and a number of stages that the friend has cleared, which has been acquired in Step S120.

As explained above, in the game system of the present embodiment, the game-playing user is provided with a benefit in accordance with a degree of progression in the game for a game-playing user. In the present embodiment, an example of the degree of progression in the game is a number of stages that a friend of the game-playing user has cleared. In the present embodiment, the benefit is that the game-playing user can progress the game advantageously by increasing attack power of a warrior card that the game-playing user uses. Thus, the game-playing user can realize that he or she has progressed the game advantageously as a result of an accomplishment by the friend. That is, the game-playing user can realize that he or she progresses the game cooperatively with the friend. The game-playing user can set a time when he or she obtains a benefit in the game as a desired time. Thus, the game-playing user can decide a time when he or she wishes to obtain the benefit in the game in accordance with his or her progression status in the game.

In the embodiment described above, the degree of progression in the game is determined based on a number of stages that the friend of the game-playing user has cleared (that is, a number of parts depending on execution results that each satisfy the criterion). With this configuration, the game-playing user is provided with a benefit in the game in accordance with a number of stages that a friend of the game-playing user have cleared. Thereby, the friend is motivated to play as many stages as possible for the sake of the game-playing user.

In determining a benefit to be provided, the number of the stages that a friend of the game-playing user has cleared may be applied. Alternatively, the benefit is determined using information (the variable M, for example) that is calculated based on comparison between the number of the stages and a reference value. In an example of the variable adjustment data illustrated in FIG. 13, if the variable M for the game-playing user is in a rage of 0 to 2, the variable M increases every time the friend of the game-playing user has cleared a predetermined number of the stages; and the game-playing user is provided with a benefit (that is, increase in attack power of the warrior card that the game-playing user uses) in response to the game-playing user's selection operation. With this example, the game-playing user is strongly conscious of a target (that is, to clear the predetermined number of stages, for example) in progressing the game cooperatively with his or her friend.

In the embodiment described above, a preferable example has been described that, according to the provider 55, increase in the variable M is determined in accordance with the variable adjustment data illustrated in FIG. 13; and accordingly, a benefit in the game provided to the game-playing user becomes gradually larger as a number of stages that have been cleared by the friend of the game-playing user in the game (that is, a number of parts depending on the execution results that each satisfy a criterion by the friend of the game-playing user; a degree of progression in the game for the friend) increases. However, setting for the increase in the variable M is not limited to one illustrated in FIG. 13. For example, if the number of the stages that has been cleared by the friend is less than a reference value, the increase in the variable M may be zero. If the number of the stages that has been cleared by the friend is equal to or greater than the reference value, the increase in the variable M may be a fixed value. Alternatively, a data table may not be provided, and the variable M may be calculated based on a function.

Note that the following advantageous effect is obtained in the case in which the variable adjustment data illustrated in FIG. 13 is applied (that is, in the case in which attack power of the game-playing user increases as a degree of progression in the game for the friend is higher). That is, the game-playing user enjoys a benefit in accordance with the degree of progress in the game for the friend of the game-playing user, and thus the game-playing user is able to realize ties with the friend. Furthermore, as a number of the friend of the game-playing user increases, the game-playing user can increase opportunities to obtain the benefit in accordance with execution of the parts in the game by many friends. Therefore, the game-playing user is motivated to voluntarily make as many friends as possible.

A degree of progression in the game for the friends has not been referred to in the embodiment described above in the case in which a game-playing user has a plurality of friends; however, such degree of progression in the game may be defined accordingly as will be explained below.

For example, the acquirer 54 may find a specific friend who has cleared the most stages (that is, a specific user whose degree of progression in the game is the highest) among the plurality of friends of the game-playing user, and acquires the number of the stages that that specific friend has cleared. With this method, if the game-playing user has even one user whose degree of progression in the game is high, the game-playing user can obtain a benefit in accordance with the degree of progression in the game for the one user

Further, the acquirer 54 may acquire information with regard to an average of the stages that respective friends of the game-playing user have cleared (that is, an average degree of progression of the game for the respective friends of the game-playing user). With this method, a benefit provided to the game-playing user can be determined in such a way that degrees of progression of the game for all friends are reflected to the benefit.

The acquirer 54 may find a specific user whose degree of intimacy with the game-playing user is the highest, or may find a specific user whose degree of progression in the game is the highest of all friends whose degree of intimacy with the game-playing user is higher than a threshold. Then, the acquirer 54 may acquire information with regard to a number of stages that the specific user has cleared. Here, a degree of intimacy is an index of strength of association between two friends. For example, the degree of intimacy may be set as high when a specific value increases. Such specific value may be: a frequency of transmission and reception with regard to cheering messages between the two friends; a number of times of transmission and reception with regard to presents such as items in the game; a number of times of battles that are played between the two friends in the case in which the battles are prepared in the game; or the like. The game-playing user may be provided with a benefit in accordance with a number of stages that a use whose degree of intimacy with the game-playing user is high, which further strengthens ties between friends who are already highly associated.

### (8) MODIFIED EXAMPLES

A battle game using cards has been described for example in the embodiment described above; however, the present invention is not applied only to the battle game. Objects other than cards, such as avatar images of users, may be applied. Alternatively, a battle game without using objects such as cards may be executed.

In the embodiment described above, a game to be executed according to the present invention is a battle game using cards; however, the game according to the present invention is not limited to such specific game, but applied to any game. For example, in games in which a user progresses stages, such as a roll playing game and a racing game, a degree of progression of the stages can be increased as a benefit that is provided to a game-playing user in accordance with the degree of progression of the stages for friends of the game-playing user. Speeding up a character or a racing car is an example of increasing the degree of progression of the stages. The present invention is preferably applied to those games. In the case in which the present invention applies to shooting games such as FPS (First Person Shooter) and TPS (Third Person Shooter), a benefit of enlarging a diameter of a sight in shooting by a game-playing user may be provided to the game-playing user, as a number of opponent objects that a friend of the game-playing user has shot increases (that is, as a degree of progression in the game becomes high).

### (8-1) Modified Example 1

The benefit provided to the game-playing user in the embodiment described above is determined on a basis of a degree of progression of stages in the game made by any one of friends of the game-playing user. In the case in which the game includes a plurality of stages (namely, parts), the benefit may be determined based on a total number of stages that respective friends have cleared (that is, a total number of parts depending on execution results that each satisfy a criterion).

With this configuration, the benefit is not determined based on a degree of progression made by a single friend of the game-playing user, but is determined based on degrees of progression of the stages made by all friends of the game-playing user. That is, the game-playing user can obtain a benefit in the game in accordance with the total number of the stages that the friends of the game-playing user have cleared. Thereby, the game-playing user can realize the game in cooperation with all friends of the game-playing user. Further, the benefit provided to the game-playing user is determined based on the total number of the stages that all friends of the game-playing user have played. Thus, in the case in which the game-playing user obtains the benefit, a burden for respective friends to play a part is relatively relaxed.

In order to realize the present modified example, a counter is provided. The counter counts up every time anyone of the friends of the game-playing user has cleared a stage. Any method may be applied that determines an increase in the variable M in accordance with value of the counter. For example, if the value of the counter is less than a reference value, the increase in the variable M may be zero. If the value of the counter is equal to or greater than the reference value, the increase in the variable M may be a fixed value.

### (8-2) Modified Example 2

In the game control device according to the modified example 1 described above, the benefit may be increased as the total number of the stages that the respective friends of a game-playing user have cleared (that is, a total number of parts depending on execution results that each satisfy a criterion) increases. For example, increase in the benefit in the game corresponds to increase of an attack power correction factor K of a warrior card of the game-playing user in the embodiment described above.

With this configuration, the game-playing user is provided with a greater benefit in the game as a total number of stages that the friends of the game-playing user have cleared increases. Thereby, the friends of the game-playing user is motivated to play as many parts as possible for the sake of the game-playing user. Furthermore, as a number of friends of the game-playing user increases, the game-playing user enjoys a synergy effect that: opportunities to be provided with the benefit increase in accordance with many friends playing stages of the game; and the benefit based on the number of the friends increases. Therefore, the game-playing user is motivated to voluntarily make as many friends as possible.

In order to realize the present modified example, a counter is provided. The counter counts up every time any one of the friends of the game-playing user has cleared a stage. Then, values in “Degree of progression” field in the variable adjustment data is replaced with the value of the counter. The CPU 21 of the game server 20 determines increase in the variable M based on the value of the counter.

### (8-3) Modified Example 3

In the embodiment described above, the provider 55 may determine the benefit in the game provided in response to the Nth power-up operation (operational input), based on a difference between a game-playing degree of progression acquired in response to the (N−1) th power-up operation and a second degree of progression acquired in response to the Nth power-up operation.

Assume a case in which: a plurality of power-up operations are permitted to obtain the benefit, although not described above; and a game-playing user can be provided at any desired time by the game-playing user after a friend of the game-playing user has cleared many stages. In that case, fairness for users may be lost. Therefore, it is preferable that a degree of progression in the game is reset every time the power-up operation is performed for obtaining the benefit. This ensures fairness for users because many attempts to perform the power-up operation to obtain the benefit without much consideration may be avoided. Furthermore, the game-playing user is likely to intentionally perform the power-up operation at a time when the game-playing user wishes to obtain the benefit, thereby making the game more strategic.

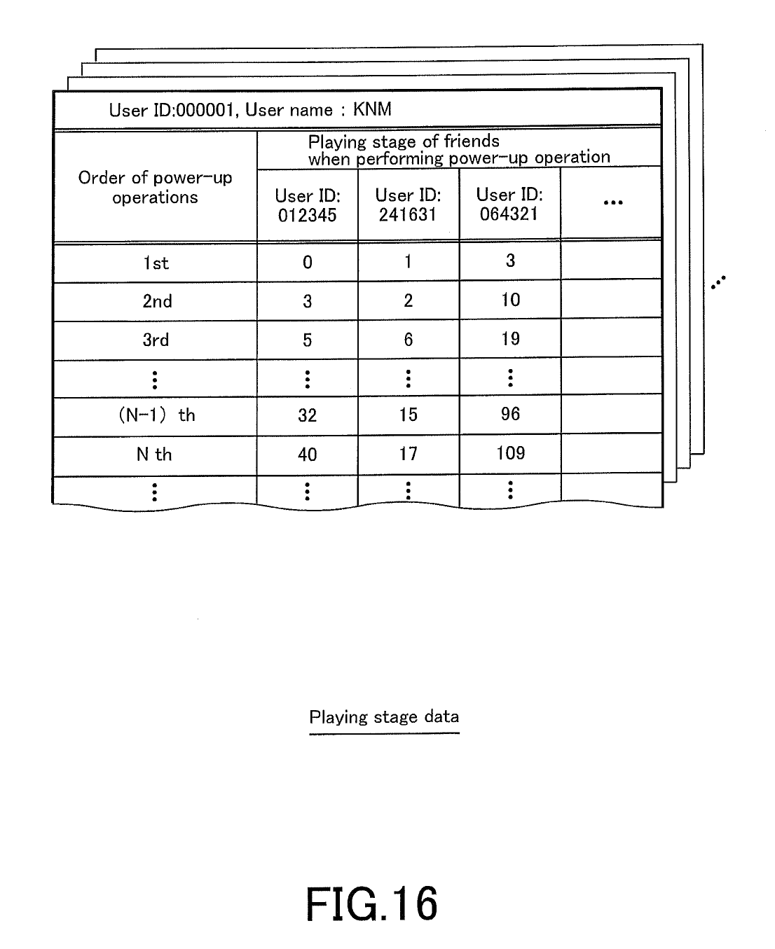

In order to realize the present exemplified example, the CPU 21 of the game server 20 reads playing stages (that is, stages that respective friends of the game-playing user are playing) from user data of the respective friends and records the playing stages in playing stage data, every time the CPU 21 recognizes that the game-playing user has performed a power-up operation. FIG. 16 illustrates an example of configuration of the playing stage data. As illustrated in FIG. 16, recorded in the playing stage data are data of stages that friends for each user (a plurality of users having user IDs such as user ID:012345, . . . , in FIG. 16) are playing when respective power-up operations (1st, 2nd, . . . , (N−1)th, Nth, . . . ) are performed. When the game-playing user performs the Nth power-up operation for example, the CPU 21 determines a benefit provided to the game-playing user based on a difference between a playing stage for the (N−1)th power-up operation and a playing stage for the Nth power-up operation. For example, in the example illustrated in FIG. 16, respective differences between a playing stage for the (N−1)th power-up operation and a playing stage for the Nth power-up operation with regard to respective friends of user ID: 012345, 241631, and 064321 are 8, 2, and 13. Here, the CPU 21 may determine a benefit provided to the game-playing user based on a difference of playing stages (namely, a difference of a degree of progression) for the friend of user ID: 064321 whose difference of playing stages is the greatest.

### (8-4) Modified Example 4

In the embodiment described above, a degree of progression in the game, that is, a number of stages that have been cleared, is an example of execution-related information; however, the execution-related information is not limited to this example. The execution-related information may be a parameter that varies depending on execution status in a game, and can be defined in accordance with nature of the game to be applied. For example, the execution-related information may be a parameter that varies by executing the game, such as a number of times of executing the game, a frequency of executing the game, or a period of time for executing the game. The execution-related information may be a parameter that varies by executing the game a plurality of times, such as: a number of items that have been obtained in the game, a number of specific missions that have been accomplished in the game, a number of stages that have been cleared in the game, a parameter like a level that increases every time a certain number of missions have been accomplished, or a number of times of selecting a specific button (the button m10 for example) on a game screen. The execution-related information may be a parameter that varies by executing a game that suffices a specific condition. The execution-related information may be set in accordance with parts in a game. For example, in the case in which a part in a game is a card drawing, the execution-related information may be a number of times of executing the card drawing, or a frequency of executing the card drawing. In the case in which a part is a quest that is comprised of a plurality of areas, the execution-related information may be a number of times of executing the quest, a frequency of executing the quest, or a value for specifying an area that is progressed in the quest.

### (8-5) Modified Example 5

In the embodiment described above, it has been explained that an example of a part, which is a game element that may be provided in a game, is a battle. Note that, as described above, parts in a game may be: a plurality of independent or mutually related game elements included in a game, such as a quest, a card drawing as well as a battle; services with reference to a game; or portions of the game, each of which is partitioned based on a condition that is arbitrarily defined in each game element. For example, if the quest includes a plurality of stages, parts may be considered as the plurality of stages.

In the case in which the game includes a plurality of parts, the acquirer 54 may acquire the execution-related information for each of the plurality of parts with regard to friend(s) associated with the game-playing user, and the provider 55 may provide the game-playing user with a benefit in the game based on the execution-related information acquired by the acquirer 54 for each of the plurality of parts.

Here, if a condition under which the benefit is provided is that a parameter as the execution-related information exceeds a reference value, the reference value may be different for each part or may be the same for all parts. Assume that the execution-related information is a frequency of executing respective parts for example. Then, in providing the game-playing user with a benefit, a reference value (threshold) for the execution-related information in a quest with regard to the friend(s) of the game-playing user, and a reference value (threshold) for the execution-related information in a battle with regard to the friend(s) of the game-playing user, may be the same or different.

A specific benefit may be provided for each part, or the same benefit may be provided for each part. For example, assume that respective parts such as a quest, a battle, and an object drawing, or the respective parts are performed under a condition that a different amount of points for the respective parts is consumed or charged. Then, points that are consumed or charged for the respective parts may be provided as a benefit for the respective parts. Assume that the execution-related information is a frequency of executing a battle, for example. Then, if an execution result for friend(S) of the game-playing user satisfies a condition for providing the game-playing user with a benefit, the benefit may be an item or a card that is usable in the battle. Assume that the execution-related information is a frequency of executing a card drawing, for example. Then, if an execution result for friend(S) of the game-playing user satisfies a condition for providing the game-playing user with a benefit, the benefit may be a drawing ticket (that is, an item that is used to allow the game-playing user to play a card drawing).

In the present modified example, the game-playing user can be provided with a benefit for each part that respective friend(S) of the game-playing user play. Thus, the game-playing user is motivated to play part(s) that his or her friend(s) have already played. The part(s) are one(s) in which execution-related information satisfies a condition for providing with a benefit. Accordingly, the game-playing user realizes cooperative relationship with the friend(s) more strongly.

In order to realize the present modified example, the CPU 21 of the game server 20 records contents of the execution-related information that have been defined (parameters such as a frequency of executing the game, or a period of time for executing the game) in the user data in association with each of the plurality of parts. The CPU 21 judges, for each user, whether a parameter as the execution-related information for each part exceeds a reference value. If it is judged that the parameter exceeds the reference value, the CPU 21 then decides to provide friends of a user to be processed with a benefit that corresponds to part(s) for which the parameter exceeds the parameter. As described above, the reference value and the benefit may be set separately for each part.

### (8-6) Modified Example 6

In the embodiment described above, the acquirer 54 may acquire, based on information of an operational input, execution-related information with regard to a game-playing user and execution-related information with regard to a friend of the game-playing user. The provider 55 may compare the execution-related information with regard to the game-playing user and the execution-related information with regard to the friend of the game-playing user, and may provide the game-playing user with a benefit based on a comparison result.

Here, a variety of embodiments in which the game-playing user is provided with the benefit based on the comparison result may be applied. For example, the benefit provided to the game-playing user may be greater, as a difference between a parameter as the execution-related information of the game-playing user and that of the friend of the game-playing user is smaller. With this embodiment, it is facilitated that the execution-related information of the game-playing user is close to that of the friend of the game-playing user, thereby advancing communication between the game-playing user and the friend of the game-playing user. For example, in the case in which the execution-related information is an area to be played in a quest that is comprised of a plurality of areas, as an area that the game-playing user is playing is closer to an area that the friend of the game-playing user is playing, the greater benefit is provide to both the game-playing user and the friend of the game-playing user. Thereby, the game-playing user and the friend of the game-playing user are expected to progress the quest while communicating each other.

If the parameter as the execution-related information of the game-playing user is smaller than that of the friend of the game-playing user, the benefit may be provide to the game-playing user. With this embodiment, if the friend of the game-playing user plays the game frequently to increase his or her own parameter, the game-playing user is able to be provided with the benefit. Thus, the friend of the game-playing user is motivated to play as much as possible for the sake of the game-playing user. For example, in the case in which the execution-related information is an area to be played in a quest that is comprised of a plurality of areas, a second user, who is a friend of the game-playing user, is motivated to advance the quest as much as possible in an attempt to provide a benefit to the game-playing user, namely a friend of the second user.

In order to realize the present modified example, the CPU 21 of the game server 20 records a predefined content of the execution-related information (parameters such as a frequency of executing each part, or a period of time for executing each part) into the user data in association with each of the plurality of parts. The CPU 21 calculates a difference between a parameter as the execution-related information for a user and that for a friend of the user. The CPU 21 then compares the difference with a reference value, and determines whether the user or the friend of the user is to be provided with a benefit. The one whose parameter is greater may be provided with the benefit. Note that the reference value and a content of the benefit may be set separately for each part.

The exemplary embodiment of the present invention has been explained in detail. However, the present invention is not limited to the aforementioned exemplary embodiment. Further, it is apparent that a variety of changes and modifications can be made for the exemplary embodiment without departing from the scope of the present invention. For example, technical matters that are described in the embodiment and the modified examples may be combined.

In the embodiment and the modified examples described above, a benefit in the game that the game-playing user is provided with is to increase an attack power correction factor K of a warrior card; however, the present invention is not limited to this example. In the case in which the advantageous effect is set with reference to the battle processing, the advantageous effect may be participation of a warrior card of the friend in a battle of the game-playing user against a monster character to support the game-playing user. Thereby, a number of warrior cards that the game-playing user uses in the battle increases and accordingly attack power of the warrior cards increases. This leads to the equivalent effect to increase in an attack power correction factor K of the warrior card that game-playing user uses in the battle. Alternatively, the benefit in the game may be that the game-playing user is provided with an item in the game, or may be that probability of the game-playing user being provided with an item in the game increases. The benefit in the game may be to increase a degree of progression in the game (a degree of progression in the quest, etc.).

In the case in which the game-playing user is provided with an item as the benefit in the game, the benefit of the item may be greater in accordance with a number of stages that a friend of the game-playing user has cleared. For example, one item A may be provided to the game-playing user if the number of stages that the friend has cleared is small, while two items A, or one item B, whose rarity is higher than the item A, may be provided to the game-playing user if the number of stages that the friend has cleared is large.

Furthermore, as described above, in the case in which a condition for providing the benefit is defined with regard to execution-related information for parts other than a battle, the benefit in the game may be set for respective parts. For example, in the case in which a condition for providing the benefit is defined with regard to execution-related information for a card drawing, the benefit in the game may be to provide points in the game to play the card drawing or to provide a drawing ticket as an item. In the case in which a condition for providing the benefit is defined with regard to execution-related information for a quest, the benefit in the game may be to provide an item that is advantageous in progressing the quest.

In the embodiment described above, an operational input such as a power-up operation is an input of pressing an operational button on the communication terminal of a user, or an input of a touch operation to a display screen of the communication terminal that includes a touch panel function; however, an operational input is not limited to these example. The operational input may be an operational input by swinging the communication terminal having an acceleration sensor, or may be an operational input by a gesture (gesture input). If a gesture is performed to a communication terminal having an imaging function, the communication terminal captures an image of the gesture and recognizes an operational input that corresponds to the gesture.

While an example has been described in which a social network game is realized, the game for which the present invention may be applied is not limited to the social network game. For example, an online game system may be applied in which a server device on a network and a home online game machine are connected. With such online game system, progress of the game can be controlled in the same way as the embodiments described above.

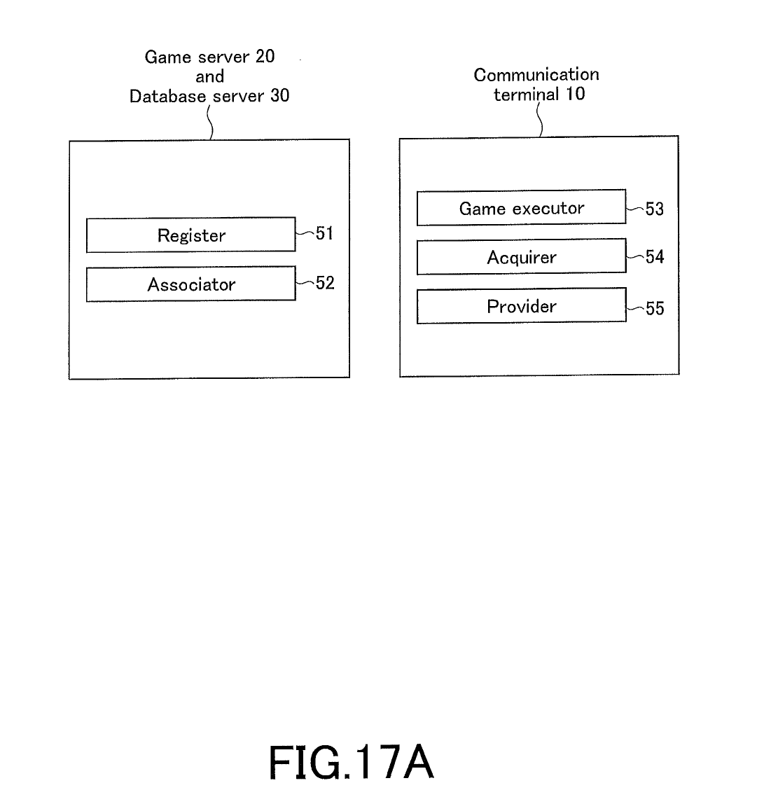

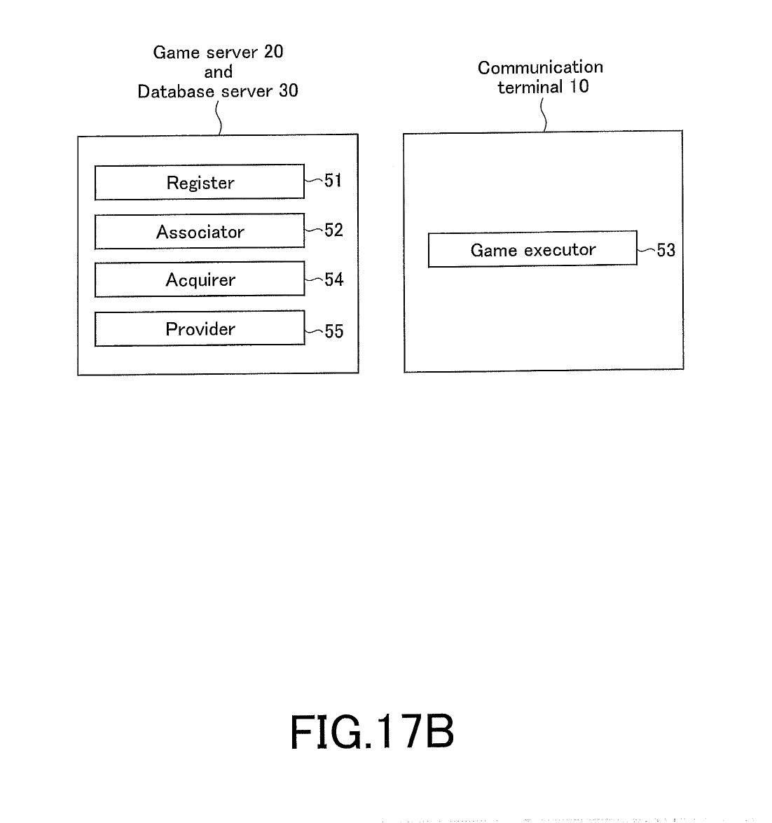

In the embodiments described above, respective functions of the associator 52, the game executor 53, the acquirer 54, and the provider 55 are configured to be realized by the game server 20 and the database server 30 on a network; however, the present invention is not limited to such configuration. All of the components may be configured to be realized by the communication terminal 10, or a portion of the components may be configured to be realized by the communication terminal 10. Because the communication terminal 10 and the game server 20 may involve the substantially same hardware configuration, the functions can be also realized by the communication terminal 10 as described in the above embodiments. Although the variable adjustment data and the attack power correction data are recorded in the ROM 22 while the monster character data is recorded in the game database 32, those data may be recorded in the ROM 12, a HDD (Hard Disk Drive; not shown), or a flash memory of the communication terminal 10 alternatively. FIGS. 17A and 17B each illustrates an example of configuration in which the functions (ones illustrated in FIG. 12) of the game control device of the present embodiment are shared between the communication terminal 10, and the game server 20 and the database server 30.

### APPENDIX

Aspects of the present invention are disclosed hereinafter.

A first aspect of the present invention is a game control device including:

an associator configured to associate a game-playing user with one or more users;

an executor configured to execute a game for the game-playing user;

an acquirer configured to acquire execution-related information indicating execution status in the game with regard to the one or more users, based on information of an operational input by the game-playing user; and

a provider configured to provide the game-playing user with a benefit in the game, based on the execution-related information acquired by the acquirer.

In this game control device, the game-playing user can be provided with a benefit in the game in accordance with a degree of progress in the game based on one or more users (referred to as “friends” hereinafter) associated with the game-playing user when the operational input is performed. Further, the game-playing user can set a time when the benefit is provided as a desired time. For example, the game-playing user can set a time when the benefit is provided in accordance with his or her progress status in the game.

“Benefit in the game” may be arbitrarily defined. “Benefit in the game” may be: setting or adjustment that is advantageous to the game-playing user in the game; providing the game-playing user with an item that is advantageous in progressing the game; or providing the game-playing user with an item that is not directly related to progression in the game. “Execution-related information” is a parameter that varies depending on execution status in the game. The execution-related information may be arbitrarily defined in accordance with nature of the game. For example, the execution-related information may be a parameter that varies by executing the game, such as a number of times of executing the game, a frequency of executing the game, or a period of time for executing the game. The execution-related information may be a parameter that varies by executing the game a plurality of times, such as: a number of stages that have been cleared in the game, a number of items that have been obtained in the game, a number of specific missions that have been accomplished in the game, a parameter like a level that increases every time a certain number of missions have been accomplished, or a number of times of selecting a specific button on a game screen. The execution-related information may be a parameter that varies by executing a game that suffices a specific condition.

“Operational input” may be: an input for pressing an operational button of a communication terminal of a user, a touch operational input on a display screen of a communication terminal that includes touch panel functions, a swinging operational input by swinging a communication terminal that includes an acceleration sensor, or an operational input with gesture (gesture input). With the gesture input, a specific gesture is performed with regard to a communication terminal that includes imaging function. The communication terminal recognizes the gesture through an image, and recognizes an operational input corresponding to the gesture.

Before “providing the game-playing user with a benefit in the game based on the execution-related information”, it may be judged whether a parameter as the execution-related information exceeds a reference value. If it is judged that the parameter exceeds the reference value, the benefit in the game may be provided. As the parameter as the execution-related information is larger, the greater benefit in the game may be provided.

In this game control device, the game may include a plurality of parts. The acquirer may acquire the execution-related information for each of the plurality of parts with regard to the one or more users, and the provider may provide the game-playing user with the benefit in the game based on the execution-related information acquired by the acquirer for each of the plurality of parts.

Here, “parts” may be a plurality of independent or mutually related game elements included in the game, such as a quest or a battle. “Parts” may be portions of the game, each of which is partitioned based on a condition that is arbitrarily defined in each game element. For example, if the quest includes a plurality of stages, “parts” may be considered as the plurality of stages. The game element may be a service provided with reference to the game, such as an object drawing. With the drawing, a user is provided with an object that is usable in the game with a condition under which a certain charge is paid or without such condition.

The expression of “provides . . . with a benefit in the game based on the execution-related information for each of the plurality of parts” means that the benefit is provided for each part based on execution-related information specified for each part. Here, if a condition under which the benefit is provided is that a parameter as the execution-related information exceeds a reference value, the reference value may be different for each part or may be the same for all parts. A specific benefit may be provided for each part, or the same benefit may be provided for all parts. For example, assume that respective parts such as a quest, a battle, and an object drawing, or the respective parts are performed under a condition that a different amount of points for the respective parts is consumed or charged. Then, points that are consumed or charged for the respective parts may be provided as a benefit for the respective parts.

With the configuration described above, the game-playing user can be provided with a benefit for respective parts that his or her friend(s) play. Thus, the game-playing user is motivated to play part(s) that his or her friend(s) have already played. Accordingly, the game-playing user realizes cooperative relationship with the friend(s) more strongly.

In this game control device, the game may include a plurality of parts. The execution-related information may be a number of parts among the plurality of parts, the number of parts depending on execution results that each satisfy a criterion, the number of parts being played by the one or more users.

With this configuration, the game-playing user is provided with a benefit in the game in accordance with a number of parts played by the friend(s) of the game-playing user, depending on the execution results that each satisfy a criterion (a number of stages that have been cleared in the game, for example). Thereby, the friend(s) are motivated to play as many parts as possible for the sake of the game-playing user. For example, if the game-playing user is provided with a benefit every time the friend(s) of the game-playing user have cleared a predetermined parts, the game-playing user is strongly conscious of a target (that is, to clear the predetermined number of stages, for example) in progressing the game cooperatively with his or her friend(s).

In this game control device, the provider may increase the benefit as the number of parts increases.

With this configuration, the game-playing user is provided with a greater benefit in the game as a number of parts depending on the execution results that each satisfy a criterion by the friends of the game-playing user (a number of stages that have been cleared by the friends of the game-playing user in the game, for example) increases. Because the game-playing user enjoys a benefit in accordance with a degree of progress in the game for the friend(s) of the game-playing user, the game-playing user is able to realize ties with the friend(s). Furthermore, as a number of the friend(s) of the game-playing user increases, the game-playing user can increase opportunities to obtain the benefit in accordance with execution of the parts in the game by many friend(s). Therefore, the game-playing user is motivated to voluntarily make as many friends as possible.

In this game control device, the game may include a plurality of parts. The execution-related information may be a total number of parts depending on execution results that each satisfy a criterion, the total number of parts being played by the one or more users.

With this configuration, a benefit that is provided to the game-playing user is determined based on a total of the degree of progress in the game for all friends of the game-playing user, not the degree of progress in the game for a single friend of the game-playing user. That is, the game-playing user is provided with a benefit in the game in accordance with a total number of parts played by all friends of the game-playing user, depending on the execution results that each satisfy a criterion (a total number of stages that have been cleared in the game, for example). Thereby, the game-playing user is able to realize progressing the game in cooperation with all friends of the game-playing user. Furthermore, the benefit provided to the game-playing user is determined based on the total number of the parts that all friends of the game-playing user have played. Thus, in the case in which the game-playing user obtains the benefit, a burden for respective friends to play a part is relatively relaxed.

In this game control device, the provider may increase the benefit as the total number of parts increases.

With this configuration, the game-playing user is provided with a greater benefit in the game as a total number of parts depending on the execution results that each satisfy a criterion by the friends of the game-playing user (a total number of stages that have been cleared by the friends of the game-playing user in the game, for example) increases. Thereby, the friends of the game-playing user is motivated to play as many parts as possible for the sake of the game-playing user. Furthermore, as a number of friends of the game-playing user increases, the game-playing user enjoys a synergy effect that: opportunities to be provided with the benefit based on degrees of progression of many friends increases; and the benefit based on the number of the friends increases. Therefore, the game-playing user is motivated to voluntarily make as many friends as possible.

In this game control device, the execution-related information may be a parameter. The parameter is: a number of times of executing the game, a frequency of executing the game, a period of time for executing the game, or a degree of progression in the game. The acquirer may acquire parameter information for one user of the one or more users, and the one parameter information of the one user is the greater than any information parameter of the one or more users.

With this configuration, if even a single user of the friends of the game-playing user frequently plays and progress the game farther, the game-playing user can obtain a benefit in accordance with execution status of the game for that user.

In this game control device, the acquirer may acquire execution-related information with regard to the game-playing user. The provider may compare the execution-related information with regard to the game-playing user and the execution-related information with regard to the one or more users based on information of an operational input by the game-playing user, and provide the game-playing user with the benefit based on a comparison result.

A variety of embodiments in which the game-playing user is provided with the benefit based on the comparison result may be applied. For example, the benefit provided to the game-playing user may be greater, as a difference between a parameter as the execution-related information of the game-playing user and that of the user associated with the game-playing user (namely, a friend) is smaller. With this embodiment, it is facilitated that the execution-related information of the game-playing user is close to that of the friend of the game-playing user, thereby advancing communication between the game-playing user and the friend of the game-playing user.

If the parameter as the execution-related information of the game-playing user is smaller than that of the friend of the game-playing user, the benefit may be provide to the game-playing user. With this embodiment, if the friend of the game-playing user plays the game frequently to increase his or her own parameter, the game-playing user is able to be provided with the benefit. Thus, the friend of the game-playing user is motivated to play as much as possible for the sake of the game-playing user.

In this game control device, the provider determines the benefit in the game provided in response to the Nth operational input, based on difference between a first execution-related information acquired in response to the (N−1)th operational input and a second execution-related information acquired in response to the Nth operational input.

Assume a case in which: a plurality of operational inputs are permitted to obtain the benefit; a parameter as the execution-related information of the friend of the game-playing user is large; and the game-playing user can obtain the benefit anytime at a desired time. In that case, fairness for users may be lost. Therefore, it is preferable that a degree of progression in the game is reset every time the operational input is performed for obtaining the benefit. This ensures fairness for users because many attempts to perform the operational input to obtain the benefit without much consideration may be avoided. Furthermore, the game-playing user is likely to intentionally perform the operational input at a time when the game-playing user wishes to obtain the benefit, thereby making the game more strategic.

A second aspect of the present invention is a game control method including:

associating a game-playing user with one or more users;

executing a game for the game-playing user;

acquiring execution-related information indicating execution status in the game with regard to the one or more users, based on information of an operational input by the game-playing user; and

providing the game-playing user with a benefit in the game, based on the execution-related information acquired by the acquiring.

A third aspect of the present invention is a non-transitory computer-readable recording medium containing a program for enabling a computer to perform a method, the method comprising:

associating a game-playing with one or more users;

executing a game for the game-playing user;

acquiring execution-related information indicating execution status in the game with regard to the one or more users, based on information of an operational input by the game-playing user; and

providing the game-playing user with a benefit in the game, based on the execution-related information acquired by the acquiring.

A fourth aspect of the present invention is a game system including a communication terminal and a game control device, the game control device configured to be accessible from the communication terminal, the server controlling game execution through the communication terminal, the game system comprising:

associating a game-playing with one or more users;

executing a game for the game-playing user;

acquiring execution-related information indicating execution status in the game with regard to the one or more users, based on information of an operational input by the game-playing user; and

providing the game-playing user with a benefit in the game, based on the execution-related information acquired by the acquiring.

1. A game control device comprising:
an associator configured to associate a game-playing user with one or more users;
an executor configured to execute a game for the game-playing user;
an acquirer configured to acquire execution-related information indicating execution status in the game with regard to one or more users, based on information of an operational input by the game-playing user; and
a provider configured to provide the game-playing user with a benefit in the game, based on the execution-related information acquired by the acquirer.

2. A game control device according to claim 1, wherein
the game includes a plurality of parts, the acquirer acquires the execution-related information for each of the plurality of parts with regard to the one or more users, and the provider provides the first user with the benefit in the game based on the execution-related information acquired by the acquirer for each of the plurality of parts.

3. A game control device according to claim 1, wherein
the game includes a plurality of parts, and the execution-related information is a number of parts among the plurality of parts, the number of parts depending on execution results that each satisfy a criterion, the number of parts being played by the one or more users.

4-13. (canceled)

14. A game control device according to claim 2, wherein
the game includes a plurality of parts, and the execution-related information is a number of parts among the plurality of parts, the number of parts depending on execution results that each satisfy a criterion, the number of parts being played by the one or more users.

15. A game control device according to claim 3, wherein
the provider increases the benefit as the number of parts increases.

16. A game control device according to claim 14, wherein
the provider increases the benefit as the number of parts increases.

17. A game control device according to claim 1, wherein
the game includes a plurality of parts, and the execution-related information is a total number of parts depending on execution results that each satisfy a criterion, the total number of parts being played by the one or more users.

18. A game control device according to claim 2, wherein
the game includes a plurality of parts, and the execution-related information is a total number of parts depending on execution results that each satisfy a criterion, the total number of parts being played by the one or more users.

19. A game control device according to claim 17, wherein
the provider increases the benefit as the total number of parts increases.

20. A game control device according to claim 18, wherein
the provider increases the benefit as the total number of parts increases.

21. A game control device according to claim 1, wherein
the execution-related information is a parameter, the parameter being: a number of times of executing the game, a frequency of executing the game, a period of time for executing the game, or a degree of progression in the game, and wherein the acquirer acquires parameter information for one user of the one or more users, and the one parameter information of the one user is the greater than any parameter information of the one or more users.

22. A game control device according to claim 2, wherein
the execution-related information is a parameter, the parameter being: a number of times of executing the game, a frequency of executing the game, a period of time for executing the game, or a degree of progression in the game, and wherein the acquirer acquires parameter information for one user of the one or more users, and the one parameter information of the one user is the greater than any parameter information of the one or more users.

23. A game control device according to claim 1, wherein
the acquirer acquires execution-related information with regard to the game-playing user, and wherein the provider compares the execution-related information with regard to the game-playing user and the execution-related information with regard to the one or more users based on information of an operational input by the game-playing user, and provides the game-playing user with the benefit based on a comparison result.

24. A game control device according to claim 2, wherein
the acquirer acquires execution-related information with regard to the game-playing user, and wherein the provider compares the execution-related information with regard to the game-playing user and the execution-related information with regard to the one or more users based on information of an operational input by the game-playing user, and provides the game-playing user with the benefit based on a comparison result.

25. A game control device according to claim 1, wherein
the provider determines the benefit in the game provided in response to the Nth operational input, based on difference between a first execution-related information acquired in response to the (N−1)th operational input and a second execution-related information acquired in response to the Nth operational input.

26. A game control device according to claim 2, wherein
the provider determines the benefit in the game provided in response to the Nth operational input, based on difference between a first execution-related information acquired in response to the (N−1)th operational input and a second execution-related information acquired in response to the Nth operational input.

27. A game control method comprising:
associating a game-playing user with one or more users;
executing a game for the game-playing user;
acquiring execution-related information indicating execution status in the game with regard to the one or more users, based on information of an operational input by the game-playing user; and
providing the game-playing user with a benefit in the game, based on the execution-related information acquired by the acquiring.

28. A non-transitory computer-readable recording medium containing a program for enabling a computer to perform a method, the method according to claim 27.

29. A game system including a communication terminal and a game control device, the game control device configured to be accessible from the communication terminal, the server controlling game execution through the communication terminal, the game system comprising:
an associator configured to associate a game-playing user with one or more users;
an executor configured to execute a game for the game-playing user;
an acquirer configured to acquire execution-related information indicating execution status in the game with regard to the one or more users, based on information of an operational input by the game-playing user; and
a provider configured to provide the game-playing user with a benefit in the game, based on the execution-related information acquired by the acquirer.
